(19) United States
(12) Patent Application Publication
(10) Pub. No.: US 2019/0113351 A1
(43) Pub. Date: Apr. 18, 2019

(54) Turn Based Autonomous Vehicle Guidance

(71) Applicant: Uber Technologies, Inc., San Francisco, CA (US)

(72) Inventor: Abhay Antony, Gurgaon (IN)

(21) Appl. No.: 15/816,242

(22) Filed: Nov. 17, 2017

Related U.S. Application Data
(60) Provisional application No. 62/571,418, filed on Oct. 12, 2017.

(51) Int. Cl. G01C 21/34; G05D 1/02; G01C 21/36; B62D 1/04

(52) U.S. Cl. CPC G01C 21/3415; G05D 1/0212; G05D 2201/0213; B62D 1/04; G01C 21/3461; G01C 21/3664

(57) ABSTRACT

Systems, methods, tangible non-transitory computer-readable media, and devices for operating an autonomous vehicle are provided. For example, a method can include determining a velocity, a trajectory, and a path for an autonomous vehicle. The path can be based on path data including a current location of the autonomous vehicle and subsequent destination locations. Navigational inputs can be received from a user, via a decoupled steering component associated with the velocity, trajectory, or the path of the autonomous vehicle, to suggest a modification of the autonomous vehicle's path. In response to the navigational inputs satisfying path modification criteria, vehicle systems can be activated to modify the path of the autonomous vehicle. The path modification criteria can be based on the velocity, the trajectory, or the path of the autonomous vehicle. Modifying the path of the autonomous vehicle can include modifying the one or more destination locations.

### RELATED APPLICATION

The present application claims the benefit of U.S. Provisional Patent Application No. 62/571,418 filed, on Oct. 12, 2017, which is hereby incorporated by reference in its entirety.

### FIELD

The present disclosure relates generally to operation of an autonomous vehicle including the modification of an autonomous vehicle path using decoupled navigational inputs.

### BACKGROUND

Vehicles, including autonomous vehicles, can navigate an environment based on various inputs including certain data. The data can be used to determine a location for the vehicle and a route for the vehicle to a destination location delineated in the data. However, the environment on which the data is based is subject to change over time. Further, the destination to which the autonomous vehicle travels and the route to the destination can change while the autonomous vehicle is in transit. Accordingly, there exists a need for an autonomous vehicle that provides users of the vehicle with a more flexible and effective way of directing the route taken by the vehicle.

### SUMMARY

Aspects and advantages of embodiments of the present disclosure will be set forth in part in the following description, or may be learned from the description, or may be learned through practice of the embodiments.

An example aspect of the present disclosure is directed to a computer-implemented method of operating an autonomous vehicle. The computer-implemented method of operating an autonomous vehicle can include determining, by a computing system that includes one or more computing devices, a velocity, a trajectory, and a path for an autonomous vehicle. The path can be based in part on path data that includes a sequence of one or more locations for the autonomous vehicle to traverse. The sequence of one or more locations can include a current location of the autonomous vehicle and one or more destination locations subsequent to the current location in the sequence. The method can also include receiving, by the computing system, one or more navigational inputs from a user inside the autonomous vehicle. The one or more navigational inputs can be used to suggest a modification of the path of the autonomous vehicle via a steering component that is in communication with one or more vehicle systems associated with at least the velocity, the trajectory, or the path of the autonomous vehicle. The method can include, responsive to the one or more navigational inputs satisfying one or more path modification criteria, activating, by the computing system, one or more vehicle systems to modify the path of the autonomous vehicle. The one or more path modification criteria can be based in part on the velocity, the trajectory, or the path of the autonomous vehicle. Modifying the path of the autonomous vehicle can include modifying the one or more destination locations.

Another example aspect of the present disclosure is directed to one or more tangible, non-transitory computer-readable media storing computer-readable instructions that when executed by one or more processors cause the one or more processors to perform operations. The operations can include determining a velocity, a trajectory, and a path for an autonomous vehicle. The path can be based in part on path data that includes a sequence of one or more locations for the autonomous vehicle to traverse. The sequence of one or more locations can include a current location of the autonomous vehicle and one or more destination locations subsequent to the current location in the sequence. The operations can also include receiving one or more navigational inputs from a user inside the autonomous vehicle. The one or more navigational inputs can be used to suggest a modification of the path of the autonomous vehicle via a steering component that is in communication with one or more vehicle systems associated with at least the velocity, the trajectory, or the path of the autonomous vehicle. The operations can include, responsive to the one or more navigational inputs satisfying one or more path modification criteria, activating one or more vehicle systems to modify the path of the autonomous vehicle. The one or more path modification criteria can be based in part on the velocity, the trajectory, or the path of the autonomous vehicle. Modifying the path of the autonomous vehicle can include modifying the one or more destination locations.

Another example aspect of the present disclosure is directed to an autonomous vehicle comprising one or more processors and one or more non-transitory computer-readable media storing instructions that when executed by the one or more processors cause the one or more processors to perform operations. The operations can include determining a velocity, a trajectory, and a path for an autonomous vehicle. The path can be based in part on path data that includes a sequence of one or more locations for the autonomous vehicle to traverse. The sequence of one or more locations can include a current location of the autonomous vehicle and one or more destination locations subsequent to the current location in the sequence. The operations can also include receiving one or more navigational inputs from a user inside the autonomous vehicle. The one or more navigational inputs can be used to suggest a modification of the path of the autonomous vehicle via a steering component that is in communication with one or more vehicle systems associated with at least the velocity, the trajectory, or the path of the autonomous vehicle. The operations can include, responsive to the one or more navigational inputs satisfying one or more path modification criteria, activating one or more vehicle systems to modify the path of the autonomous vehicle. The one or more path modification criteria can be based in part on the velocity, the trajectory, or the path of the autonomous vehicle. Modifying the path of the autonomous vehicle can include modifying the one or more destination locations.

Other example aspects of the present disclosure are directed to other systems, methods, vehicles, apparatuses, tangible non-transitory computer-readable media, and devices for operation of an autonomous vehicle including the operation of an autonomous vehicle based on decoupled navigational inputs.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example system according to example embodiments of the present disclosure;

FIG. 2 depicts an example of a control component of a vehicle control system according to example embodiments of the present disclosure;

FIG. 3 depicts an example of a control component of a vehicle control system according to example embodiments of the present disclosure;

FIG. 4 depicts an environment including an autonomous vehicle determining a maximum angle according to example embodiments of the present disclosure;

FIG. 5 depicts an environment including an autonomous vehicle determining a maximum velocity according to example embodiments of the present disclosure;

FIG. 6 depicts an environment including an autonomous vehicle determining traffic regulations according to example embodiments of the present disclosure;

FIG. 7 depicts an environment including an autonomous vehicle detecting objects according to example embodiments of the present disclosure;

FIG. 8 depicts an environment including object detection by an autonomous vehicle according to example embodiments of the present disclosure;

FIG. 9 depicts a flow diagram of an example method of operating a vehicle according to example embodiments of the present disclosure;

FIG. 10 depicts a flow diagram of an example method for operating a vehicle according to example embodiments of the present disclosure; and

FIG. 11 depicts a diagram of an example system according to example embodiments of the present disclosure.

### DETAILED DESCRIPTION

Example aspects of the present disclosure are directed to modifying the path of a vehicle (e.g., an autonomous vehicle, a semi-autonomous vehicle, or a manually operated vehicle) based at least in part on an analysis, by a computing system (e.g., a vehicle computing system), of path data (e.g., a path being traversed by the autonomous vehicle) and inputs to a steering component (e.g., navigational inputs by a passenger in the vehicle to a steering wheel) that controls the vehicle (e.g., controlling the velocity and trajectory of the vehicle). In particular, aspects of the present disclosure include determining a path for an autonomous vehicle, which can be based on path data that includes a sequence of locations for the autonomous vehicle to traverse (e.g., a sequence of geographic locations). The vehicle computing system (e.g., a computing system that can monitor and control operation of the autonomous vehicle) can determine the velocity and trajectory of the vehicle and receive one or more navigational inputs, via a steering component (e.g., a steering wheel, control stick, or other device configured to receive the one or more navigational inputs), to suggest (e.g., propose and/or recommend an action and/or plan) a modification of the path of the autonomous vehicle from the current path being traversed by the autonomous vehicle. In response to the navigational inputs satisfying one or more path modification criteria (e.g., conditions that the navigational criteria must satisfy in order for the vehicle computing system to modify the path of the autonomous vehicle), the vehicle computing system can activate one or more vehicle systems (e.g., propulsion systems, braking systems, and/or steering systems) that modify the path of the autonomous vehicle (e.g., change the sequence of locations that the autonomous vehicle will traverse).

By way of example, a passenger in a vehicle travelling on a path to the passenger's home can decide that she would like to visit a grocery store before going home. The passenger can determine that there is a grocery store one kilometer to the right of the next intersection. The passenger can then make a navigational input by turning a steering wheel in the vehicle to the right. In certain implementations, the steering wheel is decoupled from the vehicle systems that propel and/or steer the vehicle, so that, the navigational input does not activate any of the vehicle's systems until a vehicle computing system determines that the navigational input satisfies one or more path modification criteria. The vehicle computing system can then determine, that one or more path modification criteria associated with the velocity (e.g., the vehicle is not exceeding a maximum turning velocity), trajectory (e.g., the angle of the vehicle with respect to the intersection does not exceed a maximum turn angle), and/or the path of the vehicle (e.g., changing from the current vehicle path to the modified path based on the navigational input does not violate one or more traffic regulations), are satisfied. Upon determining that the one or more path modification criteria have been satisfied, the vehicle can activate vehicle systems (e.g., steering systems and/or braking systems) that can change the path of the vehicle (e.g., turn the vehicle to the right at the next intersection).

As such, the disclosed technology can more effectively and safely change the path of an autonomous vehicle in response to a navigational input. In particular, the disclosed technology can provide an alternative to more complex user inputs (e.g., user inputs including complicated interactions with a map, complex gestures and/or voice commands) by allowing a passenger to change the course of the vehicle through a more accessible form of input (e.g., a steering wheel).

The vehicle can include one or more systems including a vehicle computing system (e.g., a computing system including one or more computing devices with one or more processors and a memory) and/or a vehicle control system that can control a variety of vehicle systems and vehicle components. The vehicle computing system can process, generate, or exchange (e.g., send or receive) signals or data, including signals or data exchanged with various vehicle systems, vehicle components, other vehicles, or remote computing systems.

For example, the vehicle computing system can exchange signals (e.g., electronic signals) or data with vehicle systems including sensor systems (e.g., sensors that generate output based on the state of the physical environment external to the vehicle, including LIDAR, cameras, microphones, radar, or sonar); communication systems (e.g., wired or wireless communication systems that can exchange signals or data with other devices); navigation systems (e.g., devices that can receive signals from GPS, GLONASS, or other systems used to determine a vehicle's geographical location); notification systems (e.g., devices used to provide notifications to pedestrians, cyclists, and vehicles, including display devices, status indicator lights, or audio output systems); braking systems (e.g., brakes of the vehicle including mechanical and/or electric brakes); propulsion systems (e.g., motors or engines including electric engines or internal combustion engines); and/or steering systems used to change the path, course, or direction of travel of the vehicle.

The vehicle computing system can determine a velocity (e.g., a speed of the vehicle in a particular direction), a trajectory (e.g., a travel path of the vehicle over a period of time), and a path (e.g., a sequence of one or more locations that the vehicle will travel to) of the vehicle. The determination of the velocity and/or the trajectory of the vehicle can be based in part on output from one or more vehicle systems including one or more sensors of the vehicle (e.g., cameras, LIDAR, and/or sonar), navigational systems of the vehicle (e.g., GPS), and/or propulsion and steering systems of the vehicle (e.g., velocity based on rotations per minute from the wheels of the vehicle and the angle of the front wheels of the vehicle). In some embodiments, the vehicle computing system can determine the velocity and/or trajectory of the vehicle based on signals or data received from a remote computing device including a remote computing device at a remote location (e.g., a cluster of server computing devices that provide navigational information) and/or a remote computing device on another vehicle that uses it sensors to determine the autonomous vehicle's (e.g., the vehicle with the vehicle computing system) velocity and/or trajectory, and transmits the determined velocity and/or trajectory to the autonomous vehicle.

The vehicle computing system can determine a path (e.g., a route or course that can be traversed) for an autonomous vehicle. The path can be based in part on path data which can be received from a remote source (e.g., a remote computing device) or accessed locally (e.g., accessed on a local storage device onboard the vehicle). The path data can include one or more locations for the autonomous vehicle to traverse including a starting location (e.g., a starting location which can include a current location of the autonomous vehicle) that is associated with one or more other locations that are different from the starting location. For example, the sequence of one or more locations can include a current location of the autonomous vehicle and one or more destination locations subsequent to (i.e., following) the current location in the sequence.

Further, the one or more locations (e.g., geographic locations, addresses and/or sets of latitudes and longitudes) can be arranged in various ways including a sequence, and/or an order in which the one or more locations will be visited by the vehicle. As such, the path includes one or more locations that are traversed by the vehicle as it travels from a starting location (e.g., a current location of the vehicle) to at least one other location.

The vehicle computing system can receive (e.g., receive from a user/driver/passenger of the vehicle) one or more navigational inputs to suggest (e.g., propose and/or recommend an action and/or plan) for a modification of the path of the autonomous vehicle via a steering component that controls one or more vehicle systems associated with at least the velocity, the trajectory, or the path of the autonomous vehicle. For example, a passenger in the vehicle can generate a navigational input by turning the steering component (e.g., a steering wheel and/or control stick) in a direction indicative of a desired trajectory for the vehicle. Further, the navigational input can be based on devices remote from the vehicle including user devices (e.g., a mobile phone) that can be configured to exchange (e.g., send or receive) navigational data that is associated with the one or more navigational inputs and which can operate as the steering component for the vehicle computing system. For example, the steering component can include a mobile phone or tablet that a user can rotate in various directions to indicate a desired trajectory for the vehicle (e.g., rotating a mobile phone operating a vehicle navigation input application to the right will send one or more navigational inputs indicating a right turn to the vehicle computing system).

The steering component can receive input (e.g., navigational input from a passenger authorized to operate the vehicle) that can be used to determine the trajectory or path of the vehicle. For example, the steering component can actuate one or more vehicle systems (e.g., steering systems) based in part on the received navigational input. Further, the steering component can include one or more components or sub-components that can be associated with certain types of navigational inputs (e.g., a right turn component associated with a right turn navigational input and/or a left turn component associated with a left turn navigational input). In some embodiments, the steering component can include a steering wheel, a tiller, a tactile control component, an optical control component, a radar control component, a gyroscopic control component, and/or an auditory control component.

The vehicle computing system can determine one or more locations of one or more objects within a predetermined distance of the autonomous vehicle. For example, based on sensor output from one or more sensors of the vehicle, the vehicle computing system can determine the one or more locations of the one or more objects including geographic locations (e.g., a latitude and longitude associated with the location of each object) or relative locations of the one or more objects with respect to a point of reference (e.g., the location of each of the one or more objects relative to a portion of the vehicle).

Further, the vehicle computing system can determine one or more paths for the autonomous vehicle that traverse the one or more locations of the one or more objects. For example, based on the location of the autonomous vehicle and the one or more locations of the one or more objects, the vehicle computing system can determine a velocity and/or trajectory for each of the one or more objects and based in part on the path, velocity, and/or trajectory of the vehicle, can determine the one or more paths that will result in the vehicle passing by the one or more objects. The vehicle computing system can determine or identify the one or more paths that can result in the vehicle intersecting (e.g., contacting) at least one of the one or more objects and the one or more paths can result in the vehicle passing by the one or more objects without contacting any of the one or more objects. In some embodiments, satisfying the one or more path modification criteria can include the autonomous vehicle being able to traverse at least one of the one or more paths without intersecting the one or more locations of the one or more objects.

The vehicle computing system can determine, based in part on traffic regulation data associated with one or more traffic regulations associated with an area within a predetermined distance of the autonomous vehicle, when, whether, or that, modifying the path of the autonomous vehicle can occur without violating the one or more traffic regulations. The one or more traffic regulations can be based in part on limitations or restrictions on areas a vehicle or pedestrian can traverse and actions a vehicle or pedestrian can perform including one or more rules, regulations, or laws that define or identify the geographic areas (e.g., roads, streets, highways, sidewalks, and/or parking areas) that vehicles and/or pedestrians can lawfully traverse (e.g., vehicles can be limited from travelling on sidewalks and pedestrians can be limited from travelling through the center of a highway) and restrictions (e.g., restrictions indicated by speed limit signs, traffic lights, stop signs, yield signs, direction of travel indicators, and/or lane markings) on the ways in which vehicles and pedestrians are authorized to move through public spaces. In some embodiments, satisfying the one or more path modification criteria can be based in part on the path of the autonomous vehicle not violating the one or more traffic regulations. For example, the one or more traffic regulations can indicate that the street into which the passenger would like to direct the path of the vehicle is a one-way street in which the direction of travel is opposite the intended direction of travel for the vehicle. Accordingly, the vehicle computing system can determine that the turn into the one-way street does not satisfy the one or more traffic regulations associated with a lawful direction of travel for the vehicle.

The vehicle computing system can generate context data that can be based in part on various aspects of an operator of the vehicle associated with the one or more navigational inputs to the steering component. The context data can include or be associated with a time of day, a geographic location, and/or a passenger identity. For example, the context data can indicate the identity of different passengers of a vehicle and associate the different passenger identities with various geographic locations (e.g., pick-up locations and/or drop/off locations) and times of day (e.g., scheduled pick-up and/or drop-off times).

Further, the vehicle computing system can determine, based in part on the context data, when the one or more navigational inputs satisfy one or more navigational criteria. By way of example, the context data can include an indication that, of two passengers in a vehicle, passenger A will travel for a first leg of a trip before being dropped off at a first location, and passenger B who will travel together with passenger A for the first leg of the trip then travel alone for a second leg of the trip before being dropped off at a second location. Satisfaction of the one or more navigational criteria can be determined on the basis of the identity of the passenger and the time of day at which the one or more navigational inputs are received. Based on the context data, the vehicle computing system can accept navigational inputs only from passenger A for the first leg of the trip, then accept navigational inputs from passenger B for the second leg of the trip after passenger A has been dropped off. In some embodiments, satisfying the one or more path modification criteria is based in part on the context data satisfying the one or more navigational criteria.

The vehicle computing system can determine when, whether, or that the one or more navigational inputs satisfy one or more path modification criteria. The determination of whether, or that, the one or more navigational inputs satisfy the one or more path modification criteria can be based on a comparison of data (e.g., navigational input data) associated with the one or more navigational inputs to data (e.g., path modification criteria data) associated with the one or more path modification criteria. The one or more path modification criteria can include one or more criteria based in part on the state of the vehicle, passengers of the vehicle, or the environment external to the vehicle, that are used to determine whether one or more navigational inputs can be used to activate one or more vehicle systems to modify the path of the vehicle. For example, the one or more path modification criteria can be based in part on a vehicle velocity (e.g., a maximum velocity for a vehicle to make a turn), a vehicle trajectory (e.g., a maximum vehicle trajectory with respect to an intersection), and/or a vehicle path (e.g., one or more paths of the vehicle that do not intersect other vehicles).

Responsive to the one or more navigational inputs satisfying at least one of the one or more path modification criteria, the vehicle computing system can activate the one or more vehicle systems to modify the path of the autonomous vehicle. Activating the one or more vehicle systems to modify the path of the autonomous vehicle can include activating one or more vehicle systems (e.g., steering systems, braking, and/or propulsion/engine/motor systems) that change the velocity or trajectory of the vehicle in way that the one or more locations that the vehicle traverses as the vehicle travels along the path are also modified. In particular, modifying the path of the autonomous vehicle can include modifying the one or more destination locations that the autonomous vehicle will traverse. For example, in a situation in which a destination location lacks an address, a vehicle can travel to the destination location based on a set of geographic coordinates (e.g., latitude and longitude) associated with the destination location. Further, the path to the destination location may be very circuitous and the set of coordinates corresponding to the destination location may not be correct. However, the passenger of the vehicle may know what the destination location looks like and, upon catching sight of the destination location or receiving further directions to the destination location, the passenger can provide one or more navigational inputs (e.g., turning a steering wheel) to modify the path of the vehicle in the direction of the destination location.

In an implementation, the vehicle computing system can determine one or more intersection locations for one or more intersections of a road corresponding to the path of the autonomous vehicle. The determination of the one or more intersection locations can be based on one or more outputs including sensor output from the vehicle (e.g., cameras or LIDAR that detect the one or more intersections) and/or intersection data including locally stored or remotely accessed (e.g., via a wireless network connection) intersection data (e.g., maps that include an indication of intersections along the road traversed by the vehicle).

The vehicle computing system can determine at least one of a plurality of turn types (e.g., left turn, right turn, or U-turn) that are associated with a change in the trajectory of the autonomous vehicle within a predetermined distance of a next one of the one or more intersections. The one or more navigational inputs can be associated with at least one of the plurality of turn types. For example, a navigational input received by a steering component (e.g., a steering wheel) in which the steering wheel is rotated rightwards can be associated with a right turn type.

In some embodiments, the plurality of turn types can include a left turn type associated with the one or more navigational inputs (e.g., rotating a steering wheel or mobile phone leftwards) for the autonomous vehicle to turn left at the next one of the intersections, a right turn type associated with the one or more navigational inputs (e.g., rotating a steering wheel or mobile phone rightwards) for the autonomous vehicle to turn right at the next one of the intersections, or a U-turn type associated with the one or more navigational inputs (e.g., rotating a steering wheel full through three-hundred and sixty degrees in either a leftward or rightward direction) for the autonomous vehicle to perform a U-turn after a predetermined period of time elapses (e.g., the vehicle can perform the U-turn after a set period of time or a variable period of time based on an estimated time duration for the vehicle to decelerate to a predetermined turning speed). Further, the one or more navigational inputs associated with the plurality of turn types can be based in part on one or more movements (e.g., rotating, turning, spinning, and/or pressing) associated with the steering component. For example, the left turn type can be based in part on a leftward movement of the one or more control components that exceeds a predetermined left turn threshold amount, the right turn type can be based in part on a rightward movement of the one or more control components that exceeds a predetermined right turn threshold amount, and the U-turn type can be based in part on a leftward movement or a rightward movement of the one or more control components that exceeds a predetermined U-turn threshold amount.

The vehicle computing system can determine an intersection distance from the autonomous vehicle to the next one of the one or more intersections. For example, the distance to an intersection can be determined based in part on one or more outputs including sensor output from the vehicle (e.g., camera or LIDAR output) and intersection data including locally stored or remotely accessed (e.g., via a wireless network connection) intersection data (e.g., maps that include an indication of the distance between the location of one or more intersections and the location of the vehicle). Further, the vehicle computing system can determine based in part on the velocity of the autonomous vehicle and the intersection distance, when, whether, or that one or more intersection criteria are satisfied.

The one or more intersection criteria can be based in part on a physical relationship between the vehicle and the intersection including a distance between the vehicle and the intersection (e.g., a minimum distance between the vehicle and the intersection). For example, the vehicle computing system can determine that the one or more intersection criteria are satisfied based on a comparison of the intersection distance to a threshold distance (e.g., an intersection distance value can be generated based on the determined distance to the intersection and compared to a stored threshold distance value). Further, the one or more intersection criteria include the intersection distance satisfying a distance criterion (e.g., the intersection distance exceeding a threshold distance). In some embodiments, satisfying the one or more path modification criteria can be based in part on the intersection distance satisfying the one or more intersection criteria.

The vehicle computing system can determine a turn angle based in part on the trajectory of the autonomous vehicle relative to the next one of the one or more intersections. For example, the turn angle between the vehicle and the next one of the one or more intersections can be determined based in part on one or more outputs including sensor output from the vehicle (e.g., camera or LIDAR output) and/or intersection data including locally stored or remotely accessed (e.g., via a wireless network connection) intersection data (e.g., maps of an area within a predetermined distance of the autonomous vehicle that can be used to determine the geometry of the area including the turn angle).

The vehicle computing system can determine when, whether, or that the turn angle of the vehicle and the velocity of the autonomous vehicle satisfy one or more turn angle criteria (e.g., the determination of whether the one or more turn angle criteria is satisfied can be based in part on a comparison of the turn angle to one or more threshold turn angles and/or one or more threshold velocities). The one or more turn angle criteria can be based in part on one or more relationships (e.g., geometric relationships and/or angular relationships) of the vehicle and the intersection including a combination of the velocity of the vehicle and/or an angle of the vehicle with respect to the intersection (e.g., the turn angle being less than, equal to, or exceeding a threshold turn angle). For example, the one or more turn angle criteria can be based on the turn angle of the vehicle with respect to the intersection (e.g., the angle between the line of travel of the vehicle and the center of the entrance of the intersection) not exceeding a turn angle threshold that varies in relation to the velocity of the vehicle (e.g., the turn angle threshold is inversely proportional to the velocity of the vehicle such that a higher vehicle velocity is associated with a smaller turn angle threshold). In some embodiments, satisfying the one or more path modification criteria includes satisfying the one or more turn angle criteria and the velocity criterion.

The vehicle computing system can determine, based in part on the velocity of the vehicle and the distance to the next one of the one or more intersections, a magnitude of deceleration of the autonomous vehicle that is required for the autonomous vehicle to complete a turn at the next one of the one or more intersections (e.g., how much the velocity of the vehicle must change in order for the vehicle to complete a turn at the next one of the one or more intersections). In some embodiments, satisfying the one or more path modification criteria can be based in part on the magnitude of the deceleration of the autonomous vehicle being less than a maximum deceleration threshold. For example, the one or more path modification criteria can include a path modification criterion that the magnitude of deceleration of the vehicle cannot exceed a threshold acceleration value (e.g., 3.0 m/s²).

The systems, methods, non-transitory computer readable media, and devices in the disclosed technology can provide a variety of technical effects and benefits to the overall operation of the vehicle and the modification of a path of the vehicle in particular. The disclosed technology can more effectively receive navigational inputs from a variety of input components that facilitate a passenger's interaction with the vehicle in a way that can avoid more abstract or complicated ways of changing the vehicle's path (e.g., altering waypoints on a map or providing a series of verbal commands).

The disclosed technology can also improve the operation of the vehicle by determining the navigational inputs that are hazardous (e.g., a navigational input to steer the vehicle into another vehicle or a barrier), uncomfortable for a passenger (e.g., a navigational input that requires the vehicle to take an excessively sharp turn, and/or accelerate or brake too quickly), or in violation of one or more traffic regulations (e.g., a navigational input for the vehicle to turn the wrong way into a one-way street). Further, the disclosed technology is able to reduce the wear and tear on vehicle components by reducing the number of navigational inputs that impose excessive wear and tear on vehicle components (e.g., sharp turns that strain the vehicles steering system).

Accordingly, the disclosed technology provides more effective modification of the vehicle's path including improved vehicle safety by receiving decoupled navigational inputs and determining the safety of the navigational input before activating one or more vehicle systems to perform the navigational input. Furthermore, the disclosed technology can provide a greater level of comfort to a passenger by determining when a navigational input will result in sub-optimal vehicle conditions and adjusting the operation of the autonomous vehicle accordingly.

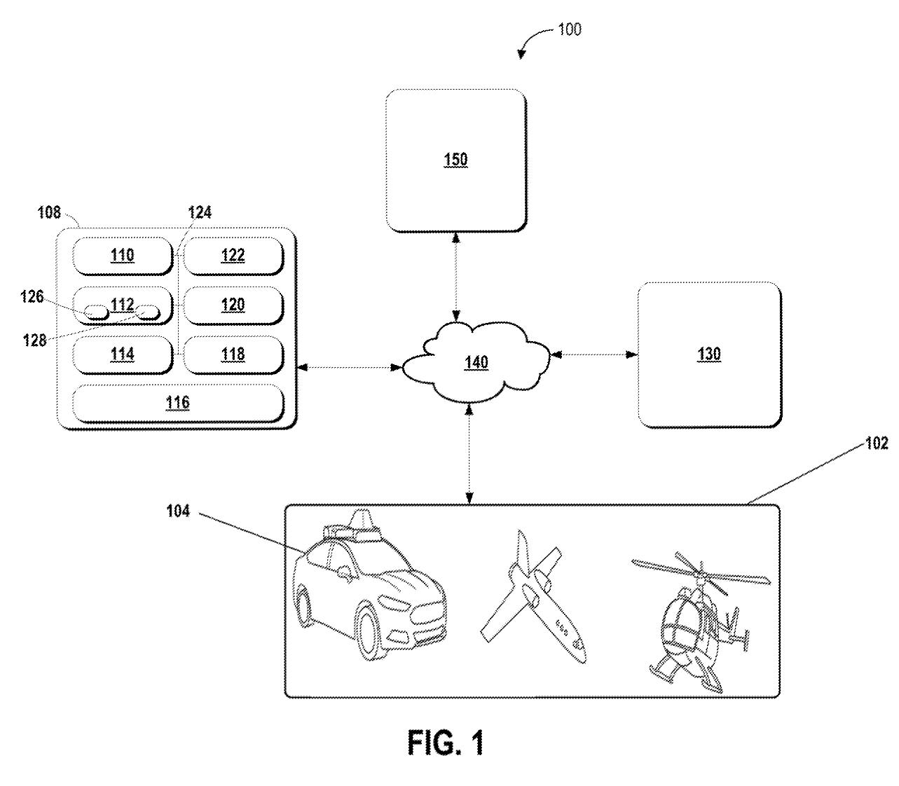

With reference now to FIGS. 1-11, example embodiments of the present disclosure will be discussed in further detail. FIG. 1 depicts a diagram of an example system 100 according to example embodiments of the present disclosure. The system 100 can include a plurality of vehicles 102; a vehicle 104; a vehicle computing system 108 that includes one or more computing devices 110; one or more data acquisition systems 112; an autonomy system 114; one or more control systems 116; one or more human machine interface systems 118; other vehicle systems 120; a communications system 122; a network 124; one or more image capture devices 126; one or more sensors 128; one or more remote computing devices 130; a communication network 140; and an operations computing system 150.

The operations computing system 150 can be associated with a service provider that provides one or more vehicle services to a plurality of users via a fleet of vehicles that includes, for example, the vehicle 104. The vehicle services can include transportation services (e.g., rideshare services), courier services, delivery services, and/or other types of services.

The operations computing system 150 can include multiple components for performing various operations and functions. For example, the operations computing system 150 can include and/or otherwise be associated with one or more remote computing devices that are remote from the vehicle 104. The one or more remote computing devices can include one or more processors and one or more memory devices. The one or more memory devices can store instructions that when executed by the one or more processors cause the one or more processors to perform operations and functions associated with operation of the vehicle including determining a path for the vehicle, receiving one or more navigational inputs associated with one or more vehicle systems, determining the state of one or more objects detected by sensors of the vehicle, and/or activating one or more vehicle systems.

For example, the operations computing system 150 can be configured to monitor and communicate with the vehicle 104 and/or its users to coordinate a vehicle service provided by the vehicle 104. To do so, the operations computing system 150 can manage a database that includes data including vehicle status data associated with the status of vehicles including the vehicle 104. The vehicle status data can include a location of the plurality of vehicles 102 (e.g., a latitude and longitude of a vehicle), the availability of a vehicle (e.g., whether a vehicle is available to pick-up or drop-off passengers and/or cargo), or the state of objects external to the vehicle (e.g., the physical dimensions and/or appearance of objects external to the vehicle).

An indication, record, and/or other data indicative of the state of one or more objects, including the physical dimensions and/or appearance of the one or more objects, can be stored locally in one or more memory devices of the vehicle 104. Furthermore, the vehicle 104 can provide data indicative of the state of the one or more objects (e.g., physical dimensions or appearance of the one or more objects) within a predefined distance of the vehicle 104 to the operations computing system 150, which can store an indication, record, and/or other data indicative of the state of the one or more objects within a predefined distance of the vehicle 104 in one or more memory devices associated with the operations computing system 150 (e.g., remote from the vehicle).

The operations computing system 150 can communicate with the vehicle 104 via one or more communications networks including the communications network 140. The communications network 140 can exchange (send or receive) signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 140 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 104.

The vehicle 104 can be a ground-based vehicle (e.g., an automobile), an aircraft, and/or another type of vehicle. The vehicle 104 can be an autonomous vehicle that can perform various actions including driving, navigating, and/or operating, with minimal and/or no interaction from a human driver. The autonomous vehicle 104 can be configured to operate in one or more modes including, for example, a fully autonomous operational mode, a semi-autonomous operational mode, a park mode, and/or a sleep mode. A fully autonomous (e.g., self-driving) operational mode can be one in which the vehicle 104 can provide driving and navigational operation with minimal and/or no interaction from a human driver present in the vehicle. A semi-autonomous operational mode can be one in which the vehicle 104 can operate with some interaction from a human driver present in the vehicle. Park and/or sleep modes can be used between operational modes while the vehicle 104 performs various actions including waiting to provide a subsequent vehicle service, and/or recharging between operational modes.

The vehicle 104 can include a vehicle computing system 108. The vehicle computing system 108 can include various components for performing various operations and functions. For example, the vehicle computing system 108 can include one or more computing devices 110 on-board the vehicle 104. The one or more computing devices 110 can include one or more processors and one or more memory devices, each of which are on-board the vehicle 104. The one or more memory devices can store instructions that when executed by the one or more processors cause the one or more processors to perform operations and functions, such as those taking the vehicle 104 out-of-service, stopping the motion of the vehicle 104, determining the state of one or more objects within a predefined distance of the vehicle 104, or generating indications associated with the state of one or more objects within a predefined distance of the vehicle 104, as described in the present disclosure.

The one or more computing devices 110 can implement, include, and/or otherwise be associated with various other systems on-board the vehicle 104. The one or more computing devices 110 can be configured to communicate with these other on-board systems of the vehicle 104. For instance, the one or more computing devices 110 can be configured to communicate with one or more data acquisition systems 112, an autonomy system 114 (e.g., including a navigation system), one or more control systems 116, one or more human machine interface systems 118, other vehicle systems 120, and/or a communications system 122. The one or more computing devices 110 can be configured to communicate with these systems via a network 124. The network 124 can include one or more data buses (e.g., controller area network (CAN)), on-board diagnostics connector (e.g., OBD-II), and/or a combination of wired and/or wireless communication links. The one or more computing devices 110 and/or the other on-board systems can send and/or receive data, messages, and/or signals, amongst one another via the network 124.

The one or more data acquisition systems 112 can include various devices configured to acquire data associated with the vehicle 104. This can include data associated with the vehicle including one or more of the vehicle's systems (e.g., health data), the vehicle's interior, the vehicle's exterior, the vehicle's surroundings, and/or the vehicle users. The one or more data acquisition systems 112 can include, for example, one or more image capture devices 126. The one or more image capture devices 126 can include one or more cameras, LIDAR systems), two-dimensional image capture devices, three-dimensional image capture devices, static image capture devices, dynamic (e.g., rotating) image capture devices, video capture devices (e.g., video recorders), lane detectors, scanners, optical readers, electric eyes, and/or other suitable types of image capture devices. The one or more image capture devices 126 can be located in the interior and/or on the exterior of the vehicle 104. The one or more image capture devices 126 can be configured to acquire image data to be used for operation of the vehicle 104 in an autonomous mode. For example, the one or more image capture devices 126 can acquire image data to allow the vehicle 104 to implement one or more machine vision techniques (e.g., to detect objects in the surrounding environment).

Additionally, or alternatively, the one or more data acquisition systems 112 can include one or more sensors 128. The one or more sensors 128 can include impact sensors, motion sensors, pressure sensors, mass sensors, weight sensors, volume sensors (e.g., sensors that can determine the volume of an object in liters), temperature sensors, humidity sensors, RADAR, sonar, radios, medium-range and long-range sensors (e.g., for obtaining information associated with the vehicle's surroundings), global positioning system (GPS) equipment, proximity sensors, and/or any other types of sensors for obtaining data indicative of parameters associated with the vehicle 104 and/or relevant to the operation of the vehicle 104. The one or more data acquisition systems 112 can include the one or more sensors 128 dedicated to obtaining data associated with a particular aspect of the vehicle 104, including, the vehicle's fuel tank, engine, oil compartment, and/or wipers. The one or more sensors 128 can also, or alternatively, include sensors associated with one or more mechanical and/or electrical components of the vehicle 104. For example, the one or more sensors 128 can be configured to detect whether a vehicle door, trunk, and/or gas cap, is in an open or closed position. In some implementations, the data acquired by the one or more sensors 128 can help detect other vehicles and/or objects, road conditions (e.g., curves, potholes, dips, bumps, and/or changes in grade), measure a distance between the vehicle 104 and other vehicles and/or objects.

The vehicle computing system 108 can also be configured to obtain map data and/or path data. For instance, a computing device of the vehicle (e.g., within the autonomy system 114) can be configured to receive map data from one or more remote computing device including the operations computing system 150 or the one or more remote computing devices 130 (e.g., associated with a geographic mapping service provider). The map data can include any combination of two-dimensional or three-dimensional geographic map data associated with the area in which the vehicle was, is, or will be travelling. The path data can be associated with the map data and include one or more destination locations that the vehicle has or will traverse.

The data acquired from the one or more data acquisition systems 112, the map data, and/or other data can be stored in one or more memory devices on-board the vehicle 104. The on-board memory devices can have limited storage capacity. As such, the data stored in the one or more memory devices may need to be periodically removed, deleted, and/or downloaded to another memory device (e.g., a database of the service provider). The one or more computing devices 110 can be configured to monitor the memory devices, and/or otherwise communicate with an associated processor, to determine how much available data storage is in the one or more memory devices. Further, one or more of the other on-board systems (e.g., the autonomy system 114) can be configured to access the data stored in the one or more memory devices.

The autonomy system 114 can be configured to allow the vehicle 104 to operate in an autonomous mode. For instance, the autonomy system 114 can obtain the data associated with the vehicle 104 (e.g., acquired by the one or more data acquisition systems 112). The autonomy system 114 can also obtain the map data and/or the path data. The autonomy system 114 can control various functions of the vehicle 104 based, at least in part, on the acquired data associated with the vehicle 104 and/or the map data to implement the autonomous mode. For example, the autonomy system 114 can include various models to perceive road features, signage, and/or objects, people, animals, etc. based on the data acquired by the one or more data acquisition systems 112, map data, and/or other data. In some implementations, the autonomy system 114 can include machine-learned models that use the data acquired by the one or more data acquisition systems 112, the map data, and/or other data to help operate the autonomous vehicle. Moreover, the acquired data can help detect other vehicles and/or objects, road conditions (e.g., curves, potholes, dips, bumps, changes in grade, or the like), measure a distance between the vehicle 104 and other vehicles or objects, etc.

The autonomy system 114 can be configured to predict the position and/or movement (or lack thereof) of such elements (e.g., using one or more odometry techniques). The autonomy system 114 can be configured to plan the motion of the vehicle 104 based, at least in part on such predictions. The autonomy system 114 can implement the planned motion to appropriately navigate the vehicle 104 with minimal or no human intervention. For instance, the autonomy system 114 can include a navigation system configured to direct the vehicle 104 to a destination location. The autonomy system 114 can regulate vehicle speed, acceleration, deceleration, steering, and/or operation of other components to operate in an autonomous mode to travel to such a destination location.

The autonomy system 114 can determine a position and/or route for the vehicle 104 in real-time and/or near real-time. For instance, using acquired data, the autonomy system 114 can calculate one or more different potential routes (e.g., every fraction of a second). The autonomy system 114 can then select which route to take and cause the vehicle 104 to navigate accordingly. By way of example, the autonomy system 114 can calculate one or more different straight paths (e.g., including some in different parts of a current lane), one or more lane-change paths, one or more turning paths, and/or one or more stopping paths. The vehicle 104 can select a path based, at last in part, on acquired data, current traffic factors, travelling conditions associated with the vehicle 104, etc. In some implementations, different weights can be applied to different criteria when selecting a path. Once selected, the autonomy system 114 can cause the vehicle 104 to travel according to the selected path.

The one or more control systems 116 of the vehicle 104 can be configured to control one or more aspects of the vehicle 104. For example, the one or more control systems 116 can control one or more access points of the vehicle 104. The one or more access points can include features such as the vehicle's door locks, trunk lock, hood lock, fuel tank access, latches, and/or other mechanical access features that can be adjusted between one or more states, positions, locations, etc. For example, the one or more control systems 116 can be configured to control an access point (e.g., door lock) to adjust the access point between a first state (e.g., lock position) and a second state (e.g., unlocked position). Additionally, or alternatively, the one or more control systems 116 can be configured to control one or more other electrical features of the vehicle 104 that can be adjusted between one or more states. For example, the one or more control systems 116 can be configured to control one or more electrical features (e.g., hazard lights, microphone) to adjust the feature between a first state (e.g., off) and a second state (e.g., on).

The one or more human machine interface systems 118 can be configured to allow interaction between a user (e.g., human), the vehicle 104 (e.g., the vehicle computing system 108), and/or a third party (e.g., an operator associated with the service provider). The one or more human machine interface systems 118 can include a variety of interfaces for the user to input and/or receive information from the vehicle computing system 108. For example, the one or more human machine interface systems 118 can include a graphical user interface, direct manipulation interface, web-based user interface, touch user interface, attentive user interface, conversational and/or voice interfaces (e.g., via text messages, chatter robot), conversational interface agent, interactive voice response (IVR) system, gesture interface, and/or other types of interfaces. The one or more human machine interface systems 118 can include one or more input devices (e.g., touchscreens, keypad, touchpad, knobs, buttons, sliders, switches, mouse, gyroscope, microphone, other hardware interfaces) configured to receive user input. The one or more human machine interfaces 118 can also include one or more output devices (e.g., display devices, speakers, lights) to receive and output data associated with the interfaces.

The other vehicle systems 120 can be configured to control and/or monitor other aspects of the vehicle 104. For instance, the other vehicle systems 120 can include software update monitors, an engine control unit, transmission control unit, the on-board memory devices, etc. The one or more computing devices 110 can be configured to communicate with the other vehicle systems 120 to receive data and/or to send to one or more signals. By way of example, the software update monitors can provide, to the one or more computing devices 110, data indicative of a current status of the software running on one or more of the on-board systems and/or whether the respective system requires a software update.

The communications system 122 can be configured to allow the vehicle computing system 108 (and its one or more computing devices 110) to communicate with other computing devices. In some implementations, the vehicle computing system 108 can use the communications system 122 to communicate with one or more user devices over the networks. In some implementations, the communications system 122 can allow the one or more computing devices 110 to communicate with one or more of the systems on-board the vehicle 104. The vehicle computing system 108 can use the communications system 122 to communicate with the operations computing system 150 and/or the one or more remote computing devices 130 over the networks (e.g., via one or more wireless signal connections). The communications system 122 can include any suitable components for interfacing with one or more networks, including for example, transmitters, receivers, ports, controllers, antennas, or other suitable components that can help facilitate communication with one or more remote computing devices that are remote from the vehicle 104.

In some implementations, the one or more computing devices 110 on-board the vehicle 104 can obtain vehicle data indicative of one or more parameters associated with the vehicle 104. The one or more parameters can include information, such as health and maintenance information, associated with the vehicle 104, the vehicle computing system 108, one or more of the on-board systems, etc. For example, the one or more parameters can include fuel level, engine conditions, tire pressure, conditions associated with the vehicle's interior, conditions associated with the vehicle's exterior, mileage, time until next maintenance, time since last maintenance, available data storage in the on-board memory devices, a charge level of an energy storage device in the vehicle 104, current software status, needed software updates, and/or other heath and maintenance data of the vehicle 104.

At least a portion of the vehicle data indicative of the parameters can be provided via one or more of the systems on-board the vehicle 104. The one or more computing devices 110 can be configured to request the vehicle data from the on-board systems on a scheduled and/or as-needed basis. In some implementations, one or more of the on-board systems can be configured to provide vehicle data indicative of one or more parameters to the one or more computing devices 110 (e.g., periodically, continuously, as-needed, as requested). By way of example, the one or more data acquisitions systems 112 can provide a parameter indicative of the vehicle's fuel level and/or the charge level in a vehicle energy storage device. In some implementations, one or more of the parameters can be indicative of user input. For example, the one or more human machine interfaces 118 can receive user input (e.g., via a user interface displayed on a display device in the vehicle's interior). The one or more human machine interfaces 118 can provide data indicative of the user input to the one or more computing devices 110. In some implementations, the one or more computing devices 130 can receive input and can provide data indicative of the user input to the one or more computing devices 110. The one or more computing devices 110 can obtain the data indicative of the user input from the one or more computing devices 130 (e.g., via a wireless communication).

The one or more computing devices 110 can be configured to determine the state of the vehicle 104 and the environment around the vehicle 104 including the state of one or more objects external to the vehicle including pedestrians, cyclists, motor vehicles (e.g., trucks, and/or automobiles), roads, waterways, and/or buildings. Further, the one or more computing devices 110 can be configured to determine one or more physical characteristics of the one or more objects including physical dimensions of the one or more objects (e.g., shape, length, width, and/or height of the one or more objects). The one or more computing devices 110 can determine a velocity, a trajectory, and/or a path for vehicle based in part on path data that includes a sequence of locations for the vehicle to traverse. Further, the one or more computing devices 110 can receive navigational inputs (e.g., from a steering system of the vehicle 104) to suggest a modification of the vehicle's path, and can activate one or more vehicle systems including steering, propulsion, lighting, notification, and/or braking systems.

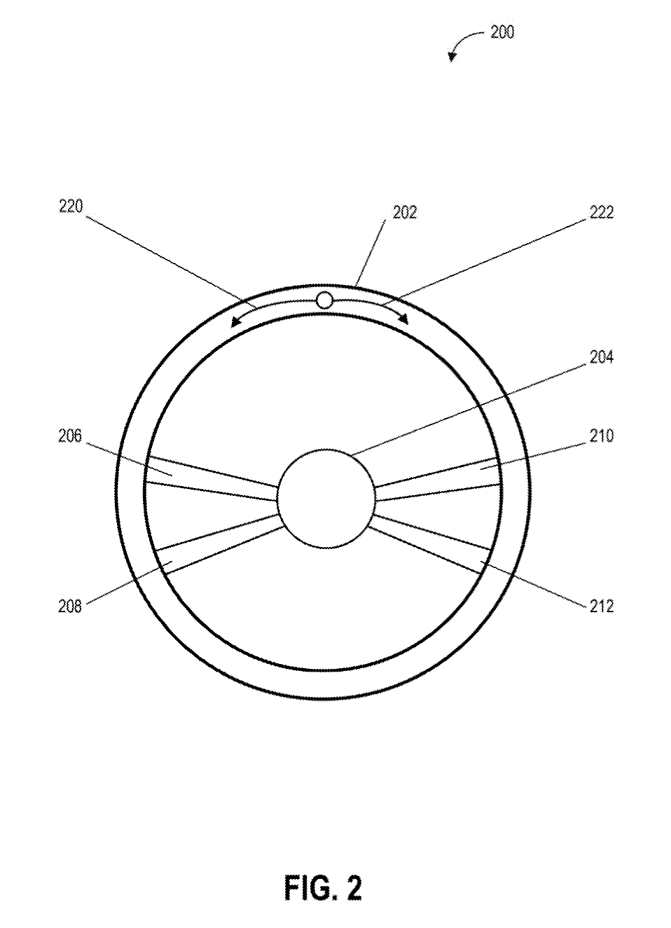

FIG. 2 depicts an example of a navigational controller of a vehicle control system according to example embodiments of the present disclosure. One or more actions or events depicted in FIG. 2 can be implemented by one or more devices (e.g., one or more computing devices) or systems including, for example, the vehicle 104, the vehicle computing system 108, or the operations computing system 150, shown in FIG. 1. FIG. 2 includes an illustration of a navigational controller 200 that can be used as an input device for one or more computing systems including, for example, the vehicle 104, the vehicle computing system 108, or the operations computing system 150, shown in FIG. 1. As shown, FIG. 2 illustrates the navigational controller 200, a control wheel 202, a central axis 204, spoke 206, spoke 208, spoke 210, spoke 212, a direction 220, and a direction 222.

The navigational controller 200 (e.g., a steering wheel) can be used to receive one or more navigational inputs to control of the movement of a vehicle (e.g., the vehicle 104) including controlling a direction in which the vehicle travels. Further, the navigational controller 200 can receive one or more inputs which can be decoupled from direct or immediate control of the vehicle and which can be used as suggestions for control of vehicle movement. In this example, the control wheel 202 is connected to the central axis 204 by the spokes 206, 208, 210, and 212. The control wheel 202 can be rotated in the direction 220 (e.g., left) to indicate a leftward turn input (e.g., an input suggesting to turn the vehicle leftward) for a vehicle control system and/or the direction 222 (right) to indicate a rightward turn input (e.g., an input suggesting to turn the vehicle rightward) for a vehicle control system (e.g., a steering system of a vehicle). For example, a passenger in a vehicle can provide one or more navigational inputs including navigational inputs in the direction 220 (e.g., rotating the control wheel 202 to the left to suggest a leftward modification of a vehicle path) and navigational inputs in the direction 222 (e.g., rotating the control wheel 202 to the right to suggest a rightward modification of a vehicle path).

In some embodiments, the navigational controller 200 can be configured to increase resistance to turning as the control wheel is turned. For example, when the control wheel 202 is turned rightwards, the resistance provided by the navigational controller 200 in a direction opposite the turning direction (e.g., resistance provided against the right turn) can increase as the control wheel 202 is turned rightwards. In this way, a passenger providing one or more navigational inputs to the navigational controller 200 can receive tactile feedback associated with the extent to which the navigational controller 200 will suggest a turn to a vehicle. Further, the resistance on the wheel, which can include resistance preventing the wheel turning, can be used as feedback to indicate that turning in a particular direction is contraindicated (e.g., turning the wheel in a direction that would lead a vehicle in the wrong direction down a one-way street).

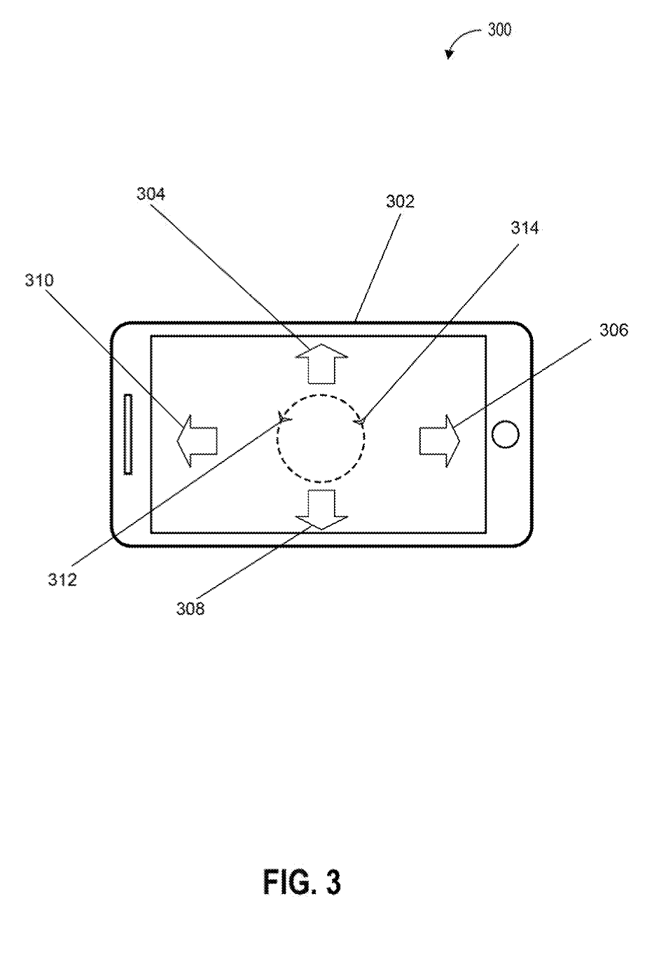

FIG. 3 depicts an example of a navigational controller of a vehicle control system according to example embodiments of the present disclosure. One or more actions or events depicted in FIG. 3 can be implemented by one or more devices (e.g., one or more computing devices) or systems including, for example, the vehicle 104, the vehicle computing system 108, or the operations computing system 150, shown in FIG. 1. FIG. 3 includes an illustration of a navigational controller 300 that can be used as an input device for one or more computing systems including, for example, the vehicle 104, the vehicle computing system 108, or the operations computing system 150, shown in FIG. 1. As shown, FIG. 3 illustrates the navigational controller 300, an enclosure 302, and an interface element 304, 306, 308, 310, a secondary interface element 312, and a secondary interface element 314.

The navigational controller 300 (e.g., a smart phone or tablet computing device) can receive one or more navigational inputs to control of the movement of a vehicle (e.g., the vehicle 104) including controlling a direction in which the vehicle travels. Further, the navigational controller 300 can receive one or more inputs (e.g., touching or tilting portions of the navigational controller 300) which can be decoupled from direct or immediate control of the vehicle and which can be used as suggestions for control of vehicle movement. The navigational controller can transmit one or more signals (e.g., wired and/or wireless signals that include data associated with one or more navigational inputs) to a vehicle or a vehicle control system that controls a vehicle.

The navigational controller 300 can receive one or more navigational inputs including navigational inputs to: the interface element 304 (e.g., tapping the interface element 304 of the navigational control system 300 to suggest a forward modification of a vehicle path); the interface element 306 (e.g., tapping the interface element 306 of the navigational control system 300 to suggest a rightward modification of a vehicle path); the interface element 310 (e.g., sliding or swiping the interface element 310 of the navigational control system 300 to suggest a leftward modification of a vehicle path); the secondary interface element 314 (e.g., sliding or swiping the secondary interface element 314 of the navigational control system 300 to suggest a rightward modification of a vehicle path); the secondary interface element 312 (e.g., tapping the secondary interface element 312 of the navigational control system 300 to suggest a leftward modification of a vehicle path); and the interface element 308 (e.g., tapping the interface element 308 of the navigational control system 300 to suggest a rearward modification of a vehicle path).

In some embodiments, the navigational controller 300 can be configured with one or more sensors (e.g., gyroscopes and/or accelerometers) to detect changes in the motion or position of the navigational controller 300. The one or more navigational inputs can be based on the motion or position of the navigational controller 300. For example, tilting, raising, lowering, rotating, or spinning the enclosure can be associated with one or more navigational inputs.

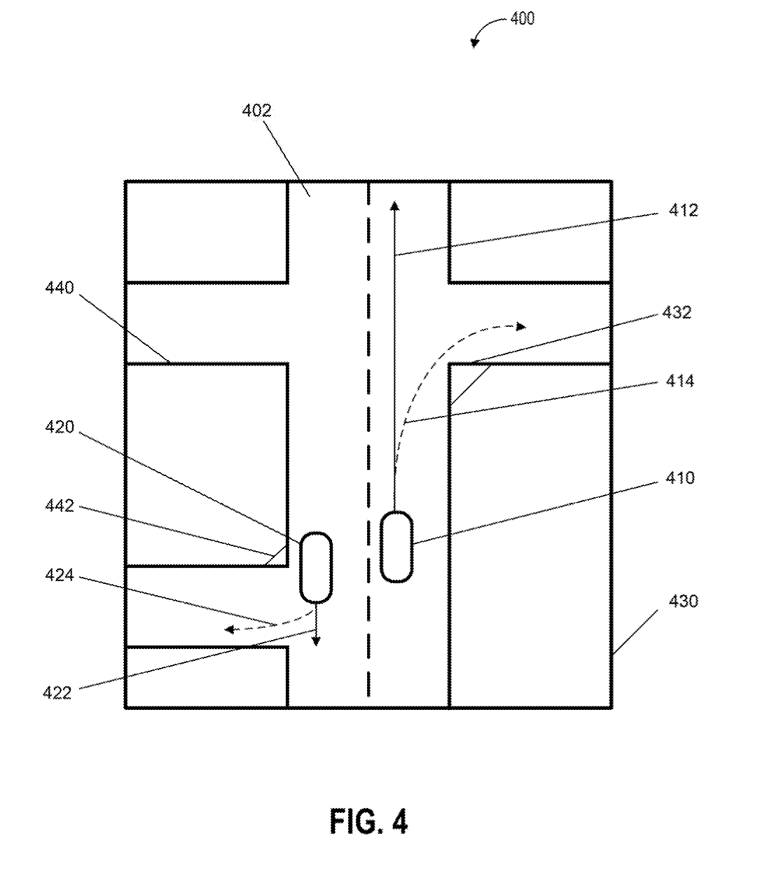

FIG. 4 depicts an environment including an autonomous vehicle navigating a corner according to example embodiments of the present disclosure. One or more actions or events depicted in FIG. 4 can be implemented by one or more devices (e.g., one or more computing devices) or systems including, for example, the vehicle 104, the vehicle computing system 108, or the operations computing system 150, shown in FIG. 1. As illustrated, FIG. 4 shows an environment 400 that includes a road 402, an autonomous vehicle 410, a path 412, a path 414, an autonomous vehicle 420, a path 422, a path 424, a building 430, a corner 432, a building 440, and a corner 442.

In this example, the autonomous vehicle 410 is travelling on the road 402 along the path 412 (e.g., a current travel path) and can receive a navigational input (e.g., turning a steering wheel to the right) from a passenger to indicate a suggested change for the autonomous vehicle 410 to travel along the path 414 (e.g., a suggested travel path). The autonomous vehicle 410 can determine, based on one or more sensors (e.g., one or more cameras, LIDAR, sonar, and/or radar devices) and/or navigational data (e.g., navigational data that includes a map of the environment 400), that at the current velocity of the autonomous vehicle 410 and with the braking capabilities of the autonomous vehicle 410, and with the distance and angle to the corner 432 of the building 430, that the autonomous vehicle 410 can make a turn that satisfies one or more one or more vehicle safety criteria associated with the integrity of the autonomous vehicle 410 (e.g., the autonomous vehicle 410 can navigate the turn without rolling over), passenger comfort (e.g., the autonomous vehicle 410 can navigate the turn without subjecting passengers to acceleration or deceleration that exceeds a respective acceleration threshold or deceleration threshold), and/or vehicle performance (e.g., the autonomous vehicle 410 can navigate the turn without unduly stressing mechanical or electrical systems of the autonomous vehicle 410).

For example, the turn angle of the autonomous vehicle 410 can be determined based in part on the angle between a path of the autonomous vehicle 410 (e.g., the path 412) and the corner 432. The turn angle can be compared to one of a plurality of turn angles that vary according to the velocity of the autonomous vehicle 410 and the distance between the autonomous vehicle 410 and the corner 432 (e.g., the maximum turn angle is inversely proportional to the velocity of the autonomous vehicle 410 and/or the distance between the autonomous vehicle 410 and the corner 432).

Travelling on the road 402, along the path 422, the autonomous vehicle 420 can receive a navigational input (e.g., turning a steering wheel to the right) from a passenger to indicate a suggested change for the autonomous vehicle 420 to travel along the path 424 (e.g., a suggested travel path). The autonomous vehicle 420 can determine, based on one or more sensors (e.g., one or more cameras, LIDAR, sonar, and/or radar devices) and/or navigational data (e.g., navigational data that includes a map of the environment 400), that at the current velocity of the vehicle 420 and with the braking capabilities of the autonomous vehicle 420, and with the distance and angle to the corner 442 of the building 440, that the autonomous vehicle 420 cannot make a turn that satisfies one or more one or more vehicle safety criteria associated with the integrity of the vehicle (e.g., the autonomous vehicle 420 can navigate the turn without losing traction), passenger comfort, and/or vehicle performance (e.g., the autonomous vehicle 420 can navigate the turn without exceeding one or more structural tolerances of the chassis or other mechanical component of the autonomous vehicle 420).

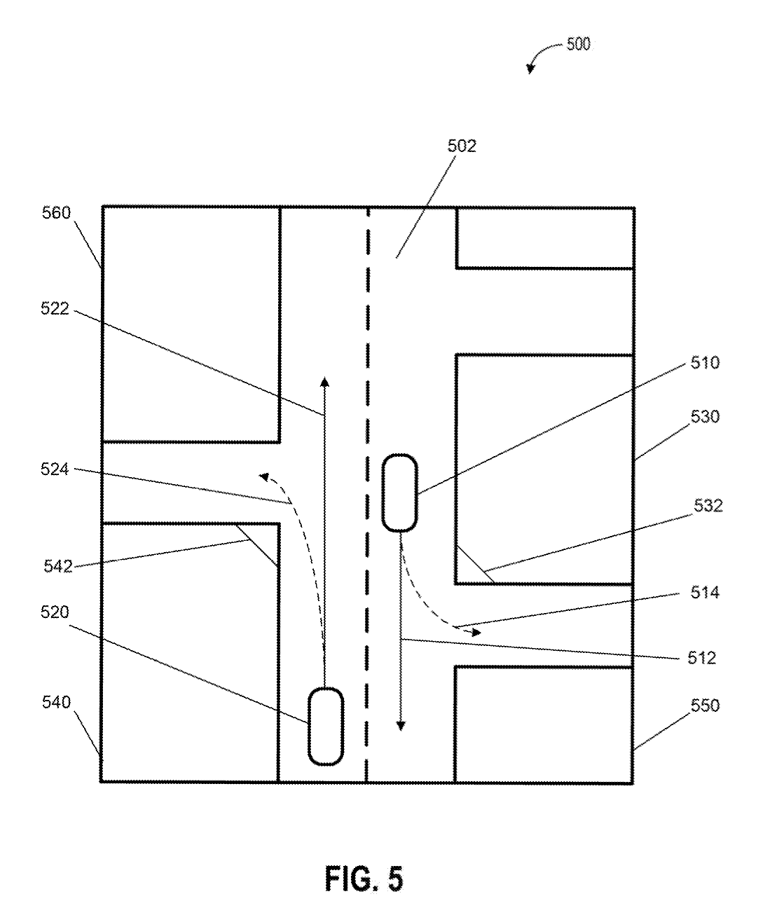

FIG. 5 depicts an environment including an autonomous vehicle determining a maximum velocity according to example embodiments of the present disclosure. One or more actions or events depicted in FIG. 4 can be implemented by one or more devices (e.g., one or more computing devices) or systems including, for example, the vehicle 104, the vehicle computing system 108, or the operations computing system 150, shown in FIG. 1. As illustrated, FIG. 5 shows an environment 500 that includes a road 502, an autonomous vehicle 510, a path 512, a path 514, an autonomous vehicle 520, a path 522, a path 524, a building 530, a corner 532, a building 540, a corner 542, the building 550, and the building 560.

In this example, the autonomous vehicle 510 (e.g., an autonomous vehicle travelling at a velocity of 80 kilometers per hour) is travelling on the road 502 along the path 512 (e.g., a current travel path) and can receive a navigational input (e.g., turning a steering wheel to the left) from a passenger to indicate a suggested change for the autonomous vehicle 510 to travel along the path 514 (e.g., a suggested travel path). The autonomous vehicle 510 can determine, based on one or more sensors (e.g., cameras, LIDAR, sonar, radar) and/or navigational data (e.g., navigational data that includes a map of the environment 500), that at the current velocity of the vehicle 510 and with the braking capabilities of the autonomous vehicle 510, and with the distance and angle to the corner 532 of the building 530, that the autonomous vehicle 510 can make a turn that satisfies one or more one or more environmental safety criteria associated with the safety of objects external to the autonomous vehicle 510 including the safety of structures or other vehicles in the environment 500 (e.g., the autonomous vehicle 510 can navigate the turn without contacting the building 530 or the building 550), and/or pedestrian safety (e.g., the autonomous vehicle 510 can navigate the turn without contacting a pedestrian). For example, the maximum velocity of the autonomous vehicle 510 can be determined based in part on the angle between a portion of the autonomous vehicle 510 (e.g., a front head lamp of the autonomous vehicle 510) and the corner 532. The turn angle can be compared to one of a plurality of turn angles that vary according to the velocity of the autonomous vehicle 510 and/or the distance between the autonomous vehicle 510 and the corner 532.

Travelling on the road 502 along the path 522, the autonomous vehicle 520 (e.g., an autonomous vehicle travelling at a velocity of 40 kilometers per hour) can receive a navigational input (e.g., turning a steering wheel to the left) from a passenger to indicate a suggested change for the autonomous vehicle 520 to travel along the path 524 (e.g., a suggested travel path). The autonomous vehicle 520 can determine, based on one or more sensors (e.g., cameras, LIDAR, sonar, radar) and/or navigational data (e.g., navigational data that includes a map of the environment 500), that at the current velocity of the vehicle 520 and with the braking capabilities of the autonomous vehicle 520, and with the distance and angle to the corner 542 of the building 552, that the autonomous vehicle 520 cannot make a turn that satisfies one or more one or more environmental safety criteria associated with the safety of objects external to the autonomous vehicle 520 including the safety of structures or other vehicles in the environment 500 (e.g., the autonomous vehicle 520 can navigate the turn without contacting the building 540 or the building 560), pedestrian and/or cyclist safety criteria, and/or pedestrian safety (e.g., the autonomous vehicle 510 can navigate the turn without coming within a threshold distance of a pedestrian and/or cyclist).

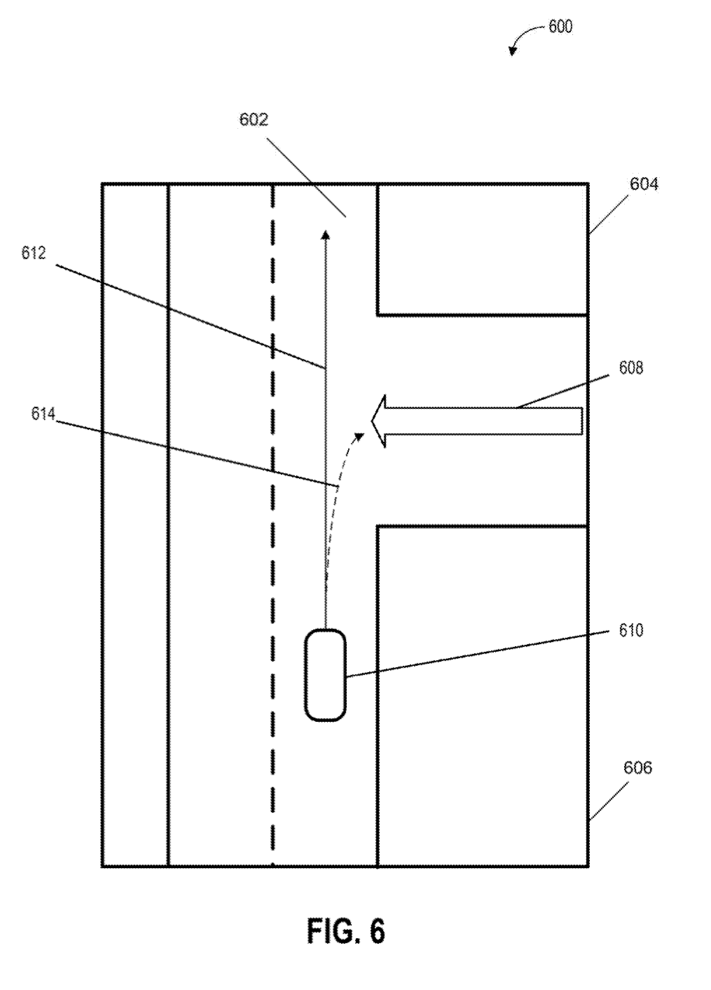

FIG. 6 depicts an environment including an autonomous vehicle determining traffic regulations according to example embodiments of the present disclosure. One or more actions or events depicted in FIG. 4 can be implemented by one or more devices (e.g., one or more computing devices) or systems including, for example, the vehicle 104, the vehicle computing system 108, or the operations computing system 150, shown in FIG. 1. As illustrated, FIG. 6 shows an environment 600 that includes a road 602, a building 604, a building 606, a street 608, a vehicle 610 (e.g., an autonomous vehicle), a path 612 (e.g., a current path of the vehicle 610), and a path 614.

In this example, the autonomous vehicle 610 is travelling on the road 602 along the path 612 (e.g., a current travel path) and can receive a navigational input (e.g., turning a steering wheel to the right) from a passenger to indicate a suggested change for the autonomous vehicle 610 to travel along the path 614 (e.g., a suggested travel path). The autonomous vehicle 610 can determine, based in part on traffic regulation data (e.g., locally stored traffic regulation data or traffic regulation data received from a remote computing device via a network) and/or one or more sensor outputs from one or more sensors of the autonomous vehicle 610 (e.g., a camera on the autonomous vehicle that detects a “one-way” sign) that the street 608 is a one-way street. Accordingly, the autonomous vehicle 610 will not use the navigational input from the passenger and will continue travelling along the path 612.

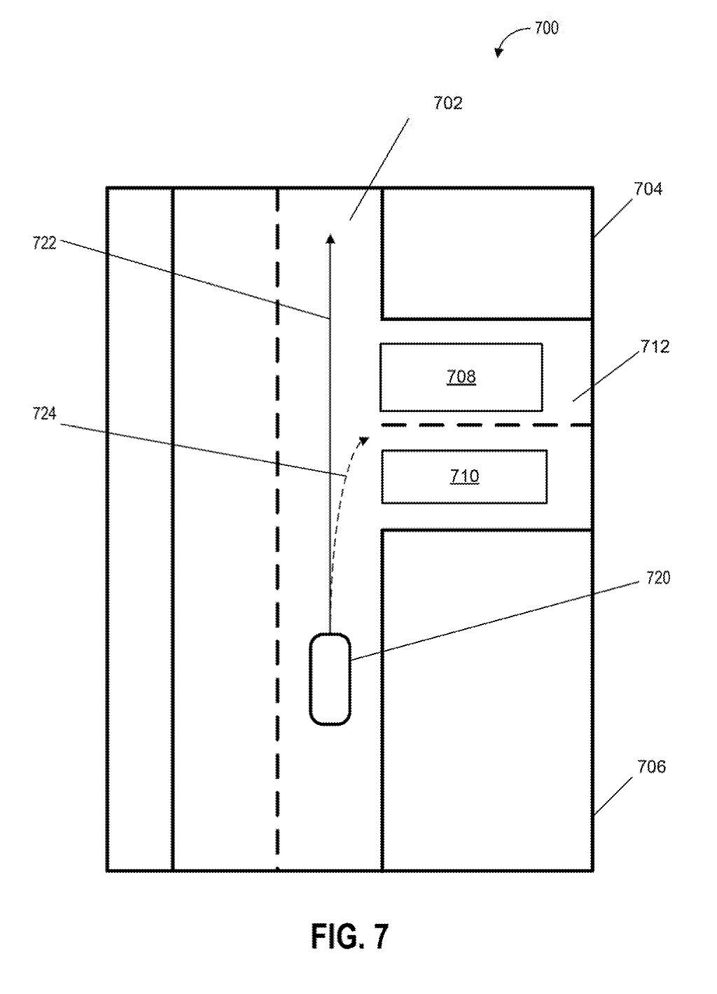

FIG. 7 depicts an environment including an autonomous vehicle detecting objects according to example embodiments of the present disclosure. One or more actions or events depicted in FIG. 4 can be implemented by one or more devices (e.g., one or more computing devices) or systems including, for example, the vehicle 104, the vehicle computing system 108, or the operations computing system 150, shown in FIG. 1. As illustrated, FIG. 7 shows an environment 700 that includes a road 702, a building 704, a building 706, an area 708 (e.g., an area in which construction is taking place and access to vehicles is limited or restricted), an area 710 (e.g., a deep ditch that presents a hazard to vehicles and people), a street 712, a vehicle 720 (e.g., an autonomous vehicle), a path 722 (e.g., a current path of the vehicle 720), and a path 724 (e.g., a path that leads to the area 708 and/or the area 710).

In this example, the autonomous vehicle 720 is travelling on the road 702 along the path 722 (e.g., a current travel path) and can receive a navigational input (e.g., turning a steering wheel to the right) from a passenger to indicate a suggested change for the autonomous vehicle 720 to travel along the path 724 (e.g., a suggested travel path). The autonomous vehicle 720 can determine, based in part on sensor outputs from one or more sensors of the autonomous vehicle 720 (e.g., a camera on the autonomous vehicle that detects an area including the area 708, the area 710, and the street 712) that the street 712 is obstructed by the area 708 (e.g., a construction zone that the vehicle 720 cannot traverse) and the area 710 (e.g., a hazard that is impassable for the vehicle 720). Accordingly, the autonomous vehicle 720 will not use the navigational input from the passenger and will continue travelling along the path 722.

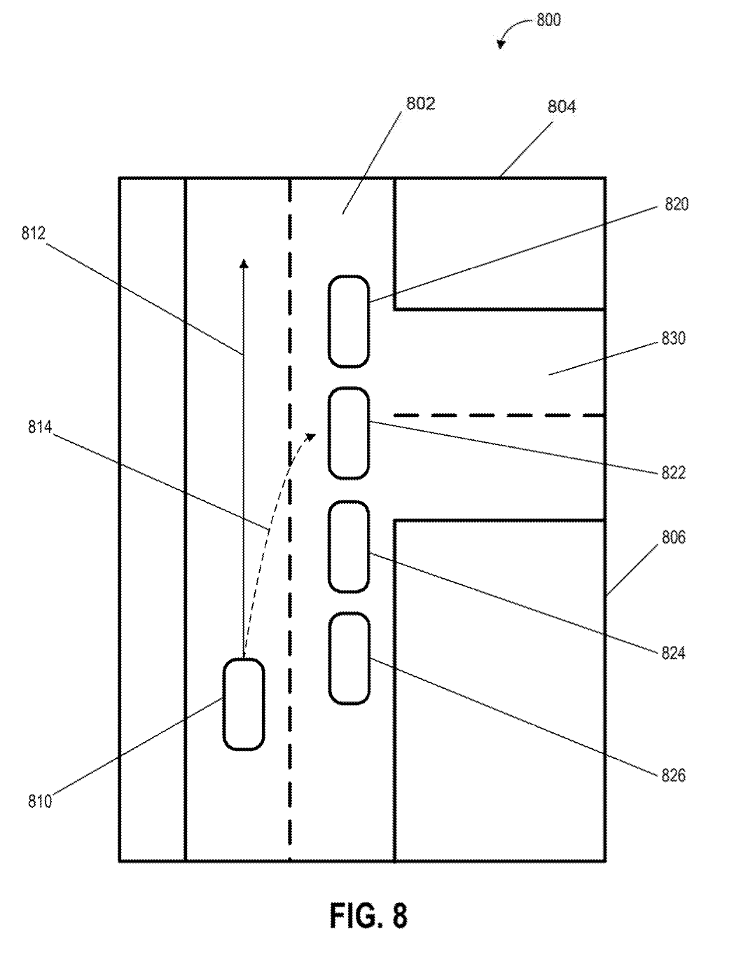

FIG. 8 depicts an environment including object detection by an autonomous vehicle according to example embodiments of the present disclosure. One or more actions or events depicted in FIG. 4 can be implemented by one or more devices (e.g., one or more computing devices) or systems including, for example, the vehicle 104, the vehicle computing system 108, or the operations computing system 150, shown in FIG. 1. As illustrated, FIG. 8 shows an environment 800 that includes a road 802, a building 804, a building 806, a vehicle 808 (e.g., a vehicle that can obstruct a suggested travel path of the vehicle 820), a vehicle 810, a path 812 (e.g., a current path of the vehicle 810), a path 814 (e.g., a suggested path for the vehicle 810), a vehicle 820, a vehicle 822, a vehicle 824, and a vehicle 826.

In this example, the autonomous vehicle 810 is travelling on the road 802 along the path 812 (e.g., a current travel path) and can receive a navigational input (e.g., turning a steering wheel to the right) from a passenger to indicate a suggested change for the autonomous vehicle 810 to travel along the path 814 (e.g., a suggested travel path). The autonomous vehicle 810 can determine, based in part on sensor outputs from one or more sensors of the autonomous vehicle 810 (e.g., a camera on the autonomous vehicle that detects the street 830) that the path 814 between the autonomous vehicle 810 and the street 830 is obstructed by the vehicles 820, 822, 824, and 826. Accordingly, the autonomous vehicle 810 will not use the navigational input from the passenger and will continue travelling along the path 812 or the autonomous vehicle 810 will slow down or stop for a predetermined period of time until a path to the street 830 is unobstructed (e.g., the vehicles 820, 822, 824, and 826 pass and no other vehicles or obstructions block the vehicle 810 from travelling to the street 830).

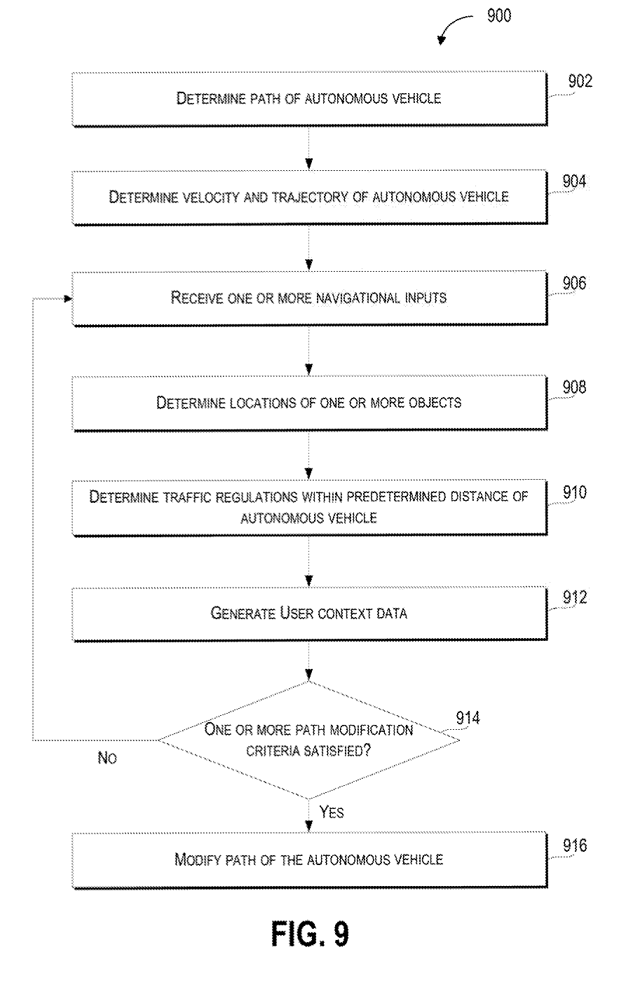

FIG. 9 depicts a flow diagram of an example method of operating a vehicle according to example embodiments of the present disclosure. One or more portions of the method 900 can be implemented by one or more devices (e.g., one or more computing devices) or systems including, for example, the vehicle 104, the vehicle computing system 108, or the operations computing system 150, shown in FIG. 1. Moreover, one or more portions of the method 900 can be implemented as an algorithm on the hardware components of the devices described herein (e.g., as in FIG. 1) to, for example, determine a path of an autonomous vehicle and modify the path of the autonomous vehicle based on navigational inputs including decoupled navigational inputs. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 902, the method 900 can include determining a path of a vehicle (e.g., the travel path of an autonomous vehicle including the vehicle 104). The path can be based in part on path data which can be received from a remote source (e.g., a remote computing device) or accessed locally (e.g., accessed on a local storage device onboard the vehicle). The path data can include one or more locations for the autonomous vehicle to traverse including a starting location (e.g., a starting location which can include a current location of the autonomous vehicle) that is associated with one or more other locations that are different from the starting location. The sequence of one or more locations can include a current location of the autonomous vehicle and one or more destination locations subsequent to (i.e., following) the current location in the sequence. Further, the sequence of one or more locations can include a circuit in which the starting location is followed by one or more intermediate locations, with the last intermediate location leading back to the starting location.

Further, the one or more locations (e.g., geographic locations, addresses and/or sets of latitudes and longitudes) can be arranged in various ways including a sequence, and/or an order in which the one or more locations will be visited by the vehicle. As such, the path includes one or more locations that are traversed by the vehicle as it travels from a starting location (e.g., a current location of the vehicle) to at least one other location.

At 904, the method 900 can include determining a velocity and a trajectory of the vehicle. The vehicle computing system can determine a velocity (e.g., a speed of the vehicle in a particular direction), a trajectory (e.g., a travel path of the vehicle over a period of time), and a path (e.g., a sequence of one or more locations that the vehicle will travel to) of the vehicle. The determination of the velocity and/or the trajectory of the vehicle can be based in part on output from one or more vehicle systems including one or more sensors of the vehicle (e.g., one or more cameras, LIDAR, sonar devices, and/or radar devices), navigational systems of the vehicle (e.g., a computing system that can receive one or more signals from a GPS), and/or propulsion and steering systems of the vehicle (e.g., velocity based on rotations per minute from the wheels of the vehicle and the angle of the front wheels of the vehicle). In some embodiments, the vehicle computing system can determine the velocity and/or trajectory of the vehicle based on signals or data received from a remote computing device including a remote computing device at a remote location (e.g., a cluster of server computing devices that provide navigational information) and/or a remote computing device on another vehicle that uses it sensors to determine the autonomous vehicle's (e.g., the vehicle with the vehicle computing system) velocity and/or trajectory, and transmits the determined velocity and/or trajectory to the autonomous vehicle.

At 906, the method 900 can include receiving one or more navigational inputs (e.g., one or more navigational inputs from a steering wheel). The vehicle computing system can receive (e.g., receive from a user/driver/passenger of the vehicle) one or more navigational inputs to suggest (e.g., propose and/or recommend an action and/or plan) for a modification of the path of the autonomous vehicle via a steering component that controls one or more vehicle systems associated with at least the velocity, the trajectory, or the path of the autonomous vehicle. For example, a passenger in the vehicle can generate a navigational input by turning the steering component (e.g., a steering wheel and/or control stick) in a direction indicative of a desired trajectory for the vehicle. Further, the navigational input can be based on devices remote from the vehicle including user devices (e.g., a mobile phone) that can be configured to exchange (e.g., send or receive) navigational input data that is associated with the one or more navigational inputs and which can operate as the steering component for the vehicle computing system. For example, the steering component can include a mobile phone or tablet that a user can tilt in various directions to indicate a desired trajectory for the vehicle (e.g., tilting a mobile phone operating a vehicle navigation input application to the right will send one or more navigational inputs indicating a right turn to the vehicle computing system).

The steering component can receive input (e.g., navigational input from a passenger authorized to operate the vehicle) that can be used to determine the trajectory or path of the vehicle. For example, the steering component can actuate one or more vehicle systems (e.g., steering systems) based in part on the received navigational input. Further, the steering component can include one or more components or sub-components that can be associated with certain types of navigational inputs (e.g., a right turn component associated with a right turn navigational input and/or a left turn component associated with a left turn navigational input). In some embodiments, the steering component can include a steering wheel, a tiller, a tactile control component, an optical control component, a radar control component, a gyroscopic control component, and/or an auditory control component.

At 908, the method 900 can include determining the location of one or more objects (e.g., the location of the one or more objects relative to the vehicle or a geographic location of the one or more objects in terms of a latitude and longitude). The vehicle computing system can determine one or more locations of one or more objects within a predetermined distance of the autonomous vehicle. For example, based on sensor output from one or more sensors of the vehicle, the vehicle computing system can determine the one or more locations of the one or more objects including geographic locations (e.g., a latitude and longitude associated with the location of each object) or relative locations of the one or more objects with respect to a point of reference (e.g., the location of each of the one or more objects relative to a portion of the vehicle).

Further, the vehicle computing system can determine one or more paths for the autonomous vehicle that traverse the one or more locations of the one or more objects. For example, based on the location of the autonomous vehicle and the one or more locations of the one or more objects, the vehicle computing system can determine a path, a velocity, and/or trajectory for each of the one or more objects and based in part on the path, velocity, and/or trajectory of the vehicle, can determine the one or more paths that will result in the vehicle not contacting the one or more objects or not coming within a predetermined distance range of the one or more objects.

The vehicle computing system can determine or identify the one or more paths that can result in the vehicle intersecting (e.g., contacting) at least one of the one or more objects and the one or more paths that can result in the vehicle passing by the one or more objects without contacting any of the one or more objects. In some embodiments, satisfying the one or more path modification criteria can include the autonomous vehicle being able to traverse at least one of the one or more paths without intersecting the one or more locations of the one or more objects. In this way, the vehicle computing system can improve passenger safety through determination of paths that do not bring the vehicle into contact with objects including other vehicles or structures (e.g., buildings).

At 910, the method 900 can include determining traffic regulations (e.g., the types of vehicle actions that are permissible within an area based on speed limits, traffic light states, stop signs, yield signs, direction signs, parking regulations, and/or turn regulations) within a predetermined distance of the vehicle. The vehicle computing system can determine, based in part on traffic regulation data associated with one or more traffic regulations associated with an area within a predetermined distance of the autonomous vehicle, when, whether, or that, modifying the path of the autonomous vehicle can occur without violating the one or more traffic regulations. The traffic regulation data can be stored locally on storage devices of the vehicle computing system and/or by accessing one or more remote computing devices that store portions of the traffic regulation data.

The one or more traffic regulations can be based in part on limitations or restrictions on areas a vehicle or pedestrian can traverse and actions a vehicle or pedestrian can perform including one or more rules, regulations, or laws that define or identify the geographic areas (e.g., roads, streets, highways, sidewalks, and/or parking areas) that vehicles and/or pedestrians can lawfully traverse (e.g., vehicles can be limited from travelling on sidewalks and pedestrians can be limited from travelling through the center of a highway) and restrictions (e.g., restrictions indicated by speed limit signs, traffic lights, stop signs, yield signs, direction of travel indicators, and/or lane markings) on the ways in which vehicles and pedestrians are authorized to move through public spaces.

In some embodiments, satisfying the one or more path modification criteria can be based in part on the path of the autonomous vehicle not violating the one or more traffic regulations. For example, the one or more traffic regulations can indicate that the area into which the passenger would like to direct the path of the vehicle is a wide foot path for pedestrians and not intended for vehicles. Accordingly, the vehicle computing system can determine that the turn into the foot path does not satisfy the one or more traffic regulations associated with lawful areas of travel for the vehicle.

At 912, the method 900 can include generating user context data (e.g., data associated with the current time and the location of the vehicle). The vehicle computing system can generate context data that can be based in part on various aspects of an operator of the vehicle associated with the one or more navigational inputs to the steering component. The context data can include or be associated with a time of day, a geographic location, and/or a passenger identity. For example, the context data can indicate the identity of different passengers of a vehicle and associate the different passenger identities with various geographic locations (e.g., pick-up locations and/or drop/off locations) and times of day (e.g., scheduled pick-up and/or drop-off times). To ensure the privacy of passengers, the use of context data associated with passenger identities can be disabled (e.g., disabled by default) and storage of the passenger identities can be encrypted and stored locally on a storage device of the vehicle computing system. Further, accessing or generating the context data associated with the passenger identities can be restricted so that the context data associated with the passenger identities is not shared or accessible outside the vehicle and generation of the context data associated with the passenger identities can require express permission on the part of a passenger.

Further, the vehicle computing system can determine, based in part on the context data, when the one or more navigational inputs satisfy one or more navigational criteria. By way of example, the context data can include an indication that, of two passengers in a vehicle, passenger A will travel for a first leg of a trip before being dropped off at a first location, and passenger B who will travel together with passenger A for the first leg of the trip then travel alone for a second leg of the trip before being dropped off at a second location. Satisfaction of the one or more navigational criteria can be determined on the basis of the identity of the passenger and the time of day at which the one or more navigational inputs are received. Based on the context data, the vehicle computing system can accept navigational inputs only from passenger A for the first leg of the trip, then accept navigational inputs from passenger B for the second leg of the trip after passenger A has been dropped off. In some embodiments, satisfying one or more path modification criteria associated with modifying a travel path of a vehicle can be based in part on the context data satisfying the one or more navigational criteria.

At 914, the method 900 can include determining whether, when, or that, one or more path modification criteria have been satisfied. In response to the one or more path modification criteria being satisfied the method 900 can proceed to 916. In response to the one or more path modification criteria not being satisfied, the method 900 can end or return to 902, 904, 906, 908, 910, or 912.

The vehicle computing system can determine when, whether, or that the one or more navigational inputs satisfy one or more path modification criteria. The determination of whether, or that, the one or more navigational inputs satisfy the one or more path modification criteria can be based on a comparison of data (e.g., navigational input data) associated with the one or more navigational inputs to data (e.g., path modification criteria data) associated with the one or more path modification criteria. The one or more path modification criteria can include one or more criteria based in part on the state of the vehicle, passengers of the vehicle, or the environment external to the vehicle, that are used to determine whether one or more navigational inputs can be used to activate one or more vehicle systems to modify the path of the vehicle. For example, the one or more path modification criteria can be based in part on a vehicle velocity (e.g., a maximum velocity for a vehicle to make a turn), a vehicle trajectory (e.g., a maximum vehicle trajectory with respect to an intersection), and/or a vehicle path (e.g., one or more paths of the vehicle that do not intersect other vehicles). Further, the one or more path modification can be based in part on context data including whether a passenger providing the one or more navigational inputs is authorized to modify the path of the vehicle.

At 916, the method 900 can include modifying the path of the vehicle (e.g., changing the direction of travel, travel route, or destination of the autonomous vehicle). Responsive to the one or more navigational inputs satisfying at least one of the one or more path modification criteria, the vehicle computing system can activate one or more vehicle systems to modify the path of the autonomous vehicle. Activating the one or more vehicle systems to modify the path of the autonomous vehicle can include activating one or more vehicle systems (e.g., steering systems, braking, and/or propulsion/engine/motor systems) that change the velocity or trajectory of the vehicle in way that the one or more locations that the vehicle traverses as the vehicle travels along the path are also modified. Further, activating the one or more vehicle systems can include the activation of vehicle systems including vehicle indicator lights (e.g., turn signal lights) to indicate to other vehicles, pedestrians, and/or cyclists, that the vehicle is preparing to change its path, vehicle sound producing devices (e.g., activating a horn to notify other vehicles, pedestrians, and/or cyclists that the vehicle is preparing to change its path).

In particular, modifying the path of the autonomous vehicle can include modifying one or more destination locations that the autonomous vehicle will traverse. For example, in a situation in which a destination location lacks an address, a vehicle can travel to the destination location based on a set of geographic coordinates (e.g., latitude and longitude) associated with the destination location or based on an image of the destination location use one or more sensors (e.g., cameras) and object detection to determine where the destination location is when the destination location is within range of the one or more sensors.

By way of further example, the path to a destination location may be complicated by obstructions including construction activity and the set of coordinates corresponding to the destination location may not be correct. However, the passenger of the vehicle may know what the destination location looks like and, upon catching sight of the destination location or receiving further directions to the destination location, the passenger can provide one or more navigational inputs (e.g., touching a navigational interface element on a smart phone that is connected wirelessly to a vehicle path control system) to modify the path of the vehicle in the direction of the destination location.

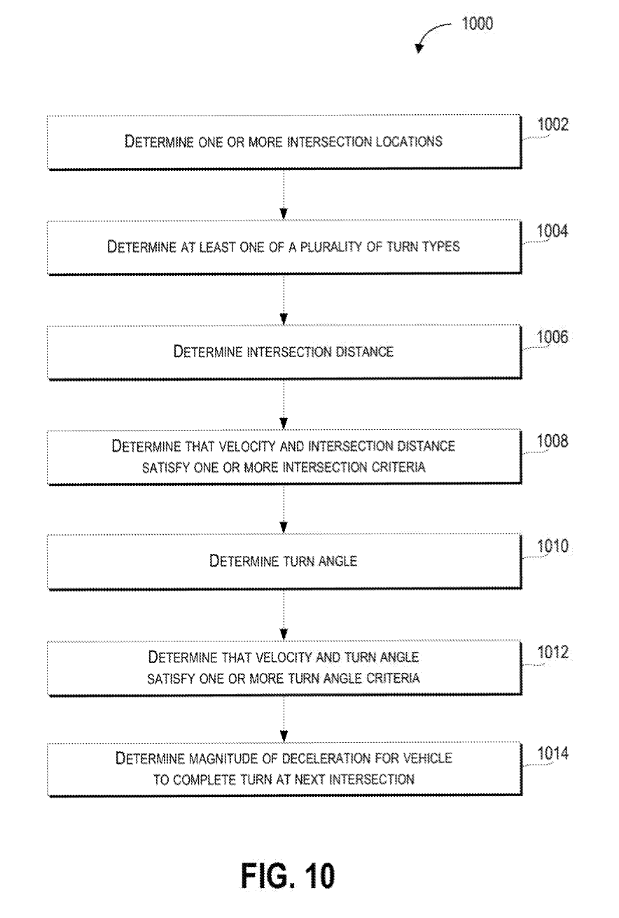

FIG. 10 depicts a flow diagram of an example method for operating a vehicle according to example embodiments of the present disclosure. One or more portions of the method 1000 can be implemented by one or more devices (e.g., one or more computing devices) or systems including, for example, the vehicle 104, the vehicle computing system 108, or the operations computing system 150, shown in FIG. 1. Moreover, one or more portions of the method 1000 can be implemented as an algorithm on the hardware components of the devices described herein (e.g., as in FIG. 1) to, for example, determine a path of an autonomous vehicle and modify the path of the autonomous vehicle based on navigational inputs including decoupled navigational inputs. FIG. 10 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 1002, the method 1000 can include determining one or more intersection locations including geographic locations where roads and/or streets intersect one another (e.g., a four way street intersection). In an implementation, the vehicle computing system can determine one or more intersection locations for one or more intersections of a road corresponding to the path of the autonomous vehicle. For example, the vehicle computing system can determine one or more intersections within a predetermined distance of the vehicle. Determination of the one or more intersection locations can be based in part on one or more outputs including sensor output from the vehicle (e.g., one or more cameras, sonar devices, radar devices, and/or LIDAR devices that detect the one or more intersections) and/or intersection data including locally stored or remotely accessed (e.g., via a wireless network connection) intersection data (e.g., maps that include an indication of intersections along the road traversed by the vehicle). In some embodiments, the one or more intersection locations can be updated in real-time to reflect the availability of intersections based on traffic flow patterns (e.g., heavy traffic congestion), construction activity, and/or hazards (e.g., flooding).

At 1004, the method 1000 can include determining at least one of a plurality of turn types (e.g., left turn, right turn, and/or U-turn). The vehicle computing system can determine at least one of a plurality of turn types (e.g., left turn, right turn, and/or U-turn) that are associated with a change in the trajectory of the autonomous vehicle within a predetermined distance of a next one of the one or more intersections. The one or more navigational inputs can be associated with at least one of the plurality of turn types. For example, a navigational input received by a steering component (e.g., a steering wheel) in which the steering wheel is rotated rightwards can be associated with a right turn type and a navigational input received by a steering component (e.g., a smart phone connected to the vehicle computing system) in which the smart phone is tilted leftwards can be associated with a left turn type.

In some embodiments, the plurality of turn types can include a left turn type associated with the one or more navigational inputs (e.g., rotating a steering wheel or mobile phone leftwards) for the autonomous vehicle to turn left at the next one of the intersections, a right turn type associated with the one or more navigational inputs (e.g., rotating a steering wheel or mobile phone rightwards) for the autonomous vehicle to turn right at the next one of the intersections, or a U-turn type associated with the one or more navigational inputs (e.g., rotating a steering wheel full through three-hundred and sixty degrees in either a leftward or rightward direction) for the autonomous vehicle to perform a U-turn after a predetermined period of time elapses (e.g., the vehicle can perform the U-turn after a set period of time or a variable period of time based on an estimated time duration for the vehicle to decelerate to a predetermined turning speed).

Further, the one or more navigational inputs associated with the plurality of turn types can be based in part on one or more movements (e.g., rotating, turning, spinning, sliding, squeezing, pushing, pulling, shaking, touching, and/or pressing) associated with the steering component. For example, the left turn type can be based in part on a leftward movement of the steering component that exceeds a predetermined left turn threshold amount, the right turn type can be based in part on a rightward movement of the steering component that exceeds a predetermined right turn threshold amount, and the U-turn type can be based in part on a leftward movement or a rightward movement of the steering component that exceeds a predetermined U-turn threshold amount (e.g., turning the steering component past one hundred and eighty degrees or turning the steering component in one direction for longer than a predetermined period of time).

At 1006, the method 1000 can include determining an intersection distance including a distance between a portion of the vehicle and a portion of the intersection (e.g., a distance between a right front headlight of a vehicle and a street sign on the corner of the intersection). The vehicle computing system can determine an intersection distance from the autonomous vehicle to the next one of the one or more intersections. For example, the distance to an intersection can be determined based in part on one or more outputs including sensor output from the vehicle (e.g., sensor output from one or more sensors including one or more cameras, sonar devices, radar devices, and/or LIDAR devices) and intersection data including locally stored or remotely accessed (e.g., via a wireless network connection) intersection data (e.g., maps that include an indication of the distance between the location of one or more intersections and the location of the vehicle). Further, the vehicle computing system can determine based in part on the velocity of the autonomous vehicle and the intersection distance, when, whether, or that one or more intersection criteria are satisfied.

At 1008, the method 1000 can include determining that a velocity and an intersection distance satisfy one or more intersection criteria. The one or more intersection criteria can be based in part on a vehicle velocity (e.g., determining that the vehicle velocity is too high to safely enter an intersection or that the vehicle cannot decelerate in time to enter the intersection), and/or a physical relationship between the vehicle and the intersection including a distance between the vehicle and the intersection (e.g., a minimum distance between the vehicle and the intersection that will allow the vehicle to navigate the intersection safely). For example, the vehicle computing system can determine that the one or more intersection criteria are satisfied based on a comparison of the intersection distance to a threshold distance (e.g., an intersection distance value can be generated based on the determined distance to the intersection and compared to a stored threshold distance value). Further, the one or more intersection criteria can include the intersection distance satisfying a distance criterion (e.g., the intersection distance exceeding a threshold distance). In some embodiments, satisfying the one or more path modification criteria can be based in part on the intersection distance satisfying the one or more intersection criteria.

At 1010, the method 1000 can include determining a turn angle (e.g., a turn angle for the vehicle to enter an intersection). The vehicle computing system can determine a turn angle based in part on the trajectory of the autonomous vehicle relative to the next one of the one or more intersections. For example, the turn angle between the vehicle and the next one of the one or more intersections can be determined based in part on one or more outputs including sensor output from the vehicle (e.g., sensor output from one or more sensors including one or more cameras, sonar devices, radar devices, and/or LIDAR output) and/or intersection data including locally stored or remotely accessed (e.g., via a wireless network connection) intersection data (e.g., maps of an area within a predetermined distance of the autonomous vehicle that can be used to determine the geometry of the area including the turn angle).

At 1012, the method 1000 can include determining that the velocity and/or turn angle satisfy one or more turn angle criteria (e.g., a combination of vehicle velocity and the turn angle that will allow the vehicle to safely enter the intersection). The vehicle computing system can determine when, whether, or that the turn angle of the vehicle and the velocity of the autonomous vehicle satisfy one or more turn angle criteria (e.g., the determination of whether the one or more turn angle criteria is satisfied can be based in part on a comparison of the turn angle to one or more threshold turn angles and/or one or more threshold velocities). The one or more turn angle criteria can be based in part on one or more relationships (e.g., geometric relationships and/or angular relationships) of the vehicle and the intersection including a combination of the velocity of the vehicle and/or an angle of the vehicle with respect to the intersection (e.g., the turn angle being less than, equal to, or exceeding a threshold turn angle). Further, the one or more turn angle criteria can be associated with an acceleration (e.g., lateral acceleration and/or forward acceleration) or deceleration of the vehicle to enter the intersection (e.g., the one or more turn angle criteria can include a maximum deceleration associated with the amount of braking the vehicle will undergo to enter the intersection).

For example, the one or more turn angle criteria can be based on the turn angle of the vehicle with respect to the intersection (e.g., the angle between the line of travel of the vehicle and the center of the entrance of the intersection) not exceeding a turn angle threshold that varies in relation to the velocity of the vehicle (e.g., the turn angle threshold can be inversely proportional to the velocity of the vehicle such that a higher vehicle velocity is associated with a smaller turn angle threshold). In some embodiments, satisfying the one or more path modification criteria includes satisfying the one or more turn angle criteria and the velocity criterion.

At 1014, the method 1000 can include determining a magnitude of deceleration for the vehicle to complete a turn at the next intersection (e.g., determining how much braking force to apply or how much the vehicle must decrease its velocity in order to complete a turn at the next intersection). The vehicle computing system can determine, based in part on the velocity of the vehicle and the distance to the next one of the one or more intersections, a magnitude of deceleration of the autonomous vehicle that is required for the autonomous vehicle to complete a turn at the next one of the one or more intersections (e.g., how much the velocity of the vehicle must change in order for the vehicle to complete a turn at the next one of the one or more intersections). In some embodiments, satisfying the one or more path modification criteria can be based in part on the magnitude of the deceleration of the autonomous vehicle being less than a maximum deceleration threshold. For example, the one or more path modification criteria can include a path modification criterion that the magnitude of deceleration of the vehicle cannot exceed a threshold acceleration value (e.g., 2.5 m/s²).

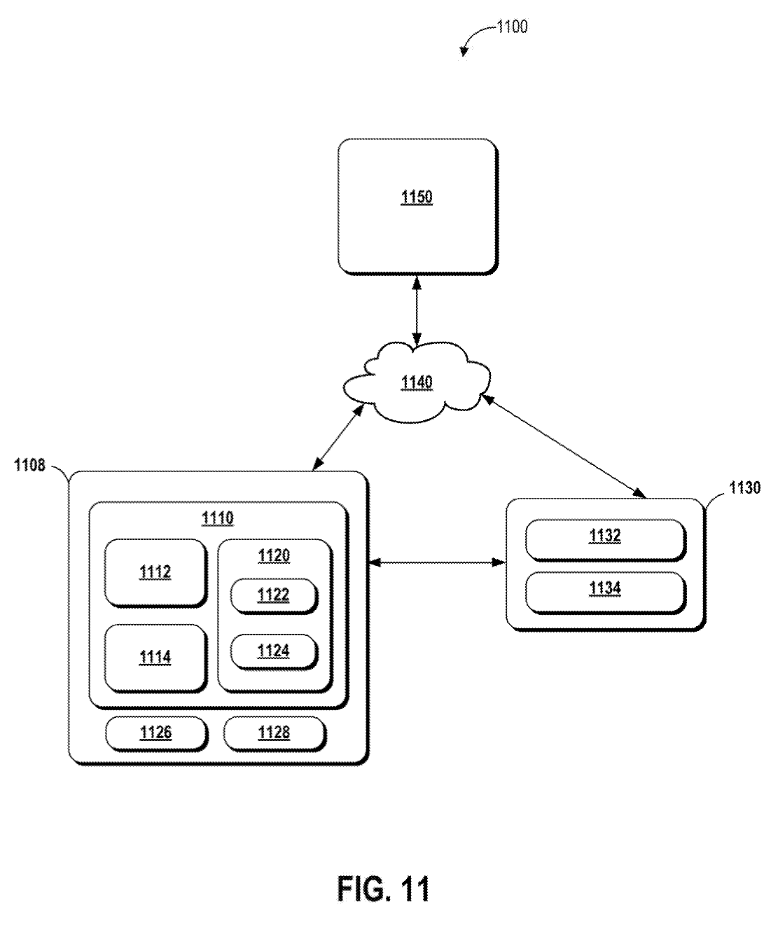

FIG. 11 depicts an example system 1100 according to example embodiments of the present disclosure. The system 1100 can include a vehicle computing system 1108 which can include some or all of the features of the vehicle computing system 108 depicted in FIG. 1; one or more computing devices 1110 which can include some or all of the features of the one or more computing devices 110; a communication interface 1112; one or more processors 1114; one or more memory devices 1120; memory system 1122; memory system 1124; one or more input devices 1126; one or more output devices 1128; one or more computing devices 1130 which can include some or all of the features of the one or more computing devices 130 depicted in FIG. 1; one or more input devices 1132; one or more output devices 1134; a network 1140 which can include some or all of the features of the network 140 depicted in FIG. 1; and an operations computing system 1150 which can include some or all of the features of the operations computing system 150 depicted in FIG. 1.

The vehicle computing system 1108 can include the one or more computing devices 1110. The one or more computing devices 1110 can include one or more processors 1114 which can be included on-board a vehicle including the vehicle 104 and one or more memory devices 1120 which can be included on-board a vehicle including the vehicle 104. The one or more processors 1114 can be any processing device including a microprocessor, microcontroller, integrated circuit, an application specific integrated circuit (ASIC), a digital signal processor (DSP), a field-programmable gate array (FPGA), logic device, one or more central processing units (CPUs), graphics processing units (GPUs), and/or processing units performing other specialized calculations. The one or more processors 1114 can include a single processor or a plurality of processors that are operatively and/or selectively connected. The one or more memory devices 1120 can include one or more non-transitory computer-readable storage media, such as RAM, ROM, EEPROM, EPROM, flash memory devices, magnetic disks, and/or combinations thereof.

The one or more memory devices 1120 can store data or information that can be accessed by the one or more processors 1114. For instance, the one or more memory devices 1120 which can be included on-board a vehicle including the vehicle 104, can include a memory system 1122 that can store computer-readable instructions that can be executed by the one or more processors 1114. The memory system 1122 can include software written in any suitable programming language that can be implemented in hardware (e.g., computing hardware). Further, the memory system 1122 can include instructions that can be executed in logically and/or virtually separate threads on the one or more processors 1114. The memory system 1122 can include any set of instructions that when executed by the one or more processors 1114 cause the one or more processors 1114 to perform operations.

For example, the one or more memory devices 1120 which can be included on-board a vehicle including the vehicle 104 can store instructions, including specialized instructions, that when executed by the one or more processors 1114 on-board the vehicle cause the one or more processors 1114 to perform operations such as any of the operations and functions of the one or more computing devices 1110 or for which the one or more computing devices 1110 are configured, including the operations for receiving data (e.g., path data, context data, and/or traffic regulation data), receiving one or more navigational inputs, and/or activating one or more vehicle systems (e.g., one or more portions of method 900 or method 1000), or any other operations or functions for operation of a vehicle, as described in the present disclosure.

The one or more memory devices 1120 can include a memory system 1124 that can store data that can be retrieved, manipulated, created, and/or stored by the one or more computing devices 1110. The data stored in memory system 1124 can include, for instance, data associated with a vehicle including the vehicle 104; data acquired by the one or more data acquisition systems 112; path data associated with a path traversed by a vehicle; context data associated with the state of an environment; traffic regulation data associated with traffic regulations in an environment; data associated with user input; data associated with one or more actions and/or control command signals; data associated with users; and/or other data or information. The data in the memory system 1124 can be stored in one or more databases. The one or more databases can be split up so that they are located in multiple locales on-board a vehicle which can include the vehicle 104. In some implementations, the one or more computing devices 1110 can obtain data from one or more memory devices that are remote from a vehicle, which can include the vehicle 104.

The environment 1100 can include the network 1140 (e.g., a communications network) which can be used to exchange (send or receive) signals (e.g., electronic signals) or data (e.g., data from a computing device) including signals or data exchanged between computing devices including the operations computing system 1150, the vehicle computing system 1108, or the one or more computing devices 1130. The network 1140 can include any combination of various wired (e.g., twisted pair cable) and/or wireless communication mechanisms (e.g., cellular, wireless, satellite, microwave, and radio frequency) and/or any desired network topology (or topologies). For example, the communications network 140 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from a vehicle including the vehicle 104.

The one or more computing devices 1110 can also include communication interface 1112 used to communicate with one or more other systems which can be included on-board a vehicle including the vehicle 104 (e.g., over the network 1140. The communication interface 1112 can include any suitable components for interfacing with one or more networks, including for example, transmitters, receivers, ports, controllers, antennas, other hardware and/or software.

The vehicle computing system 1108 can also include one or more input devices 1126 and/or one or more output devices 1128. The one or more input devices 1126 and/or the one or more output devices 1128 can be included and/or otherwise associated with a human-machine interface system. The one or more input devices 1126 can include, for example, hardware for receiving information from a user, such as a touch screen, touch pad, mouse, data entry keys, speakers, and/or a microphone suitable for voice recognition. The one or more output devices 1128 can include one or more display devices (e.g., display screen, CRT, LCD) and/or one or more audio output devices (e.g., loudspeakers). The display devices and/or the audio output devices can be used to facilitate communication with a user. For example, a human operator (e.g., associated with a service provider) can communicate with a current user of a vehicle including the vehicle 104 via at least one of the display devices and the audio output devices.

The one or more computing devices 1130 can include various types of computing devices. For example, the one or more computing devices 1130 can include a phone, a smart phone, a tablet, a personal digital assistant (PDA), a laptop computer, a computerized watch (e.g., a smart watch), computerized eyewear, computerized headwear, other types of wearable computing devices, a gaming system, a media player, an e-book reader, and/or other types of computing devices. The one or more computing devices 1130 can be associated with a user. The one or more computing devices 1130 described herein can also be representative of a user device that can be included in the human machine interface system of a vehicle including the vehicle 104.

The one or more computing devices 1130 can include one or more input devices 1132 and/or one or more output devices 1134. The one or more input devices 1132 can include, for example, hardware for receiving information from a user, such as a touch screen, touch pad, mouse, data entry keys, speakers, and/or a microphone suitable for voice recognition. The one or more output devices 1134 can include hardware for providing content for display. For example, the one or more output devices 1134 can include a display device (e.g., display screen, CRT, LCD), which can include hardware for a user interface.

The technology discussed herein makes reference to computing devices, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, computer-implemented processes discussed herein can be implemented using a single computing device or multiple computing devices working in combination. Databases and applications can be implemented on a single system or distributed across multiple systems. Distributed components can operate sequentially or in parallel.

Furthermore, computing tasks discussed herein as being performed at computing devices remote from the vehicle (e.g., the operations computing system and its associated computing devices) can instead be performed at the vehicle (e.g., via the vehicle computing system). Such configurations can be implemented without deviating from the scope of the present disclosure.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of operating an autonomous vehicle, the computer-implemented method comprising:
determining, by a computing system comprising one or more computing devices, a velocity, a trajectory, and a path for an autonomous vehicle, the path based in part on path data comprising a sequence of one or more locations for the autonomous vehicle to traverse, wherein the sequence of one or more locations comprises a current location of the autonomous vehicle and one or more destination locations subsequent to the current location in the sequence;
receiving, by the computing system, one or more navigational inputs from a user inside the autonomous vehicle to suggest a modification of the path of the autonomous vehicle via a steering component that is in communication with one or more vehicle systems associated with at least the velocity, the trajectory, or the path of the autonomous vehicle; and
responsive to the one or more navigational inputs satisfying one or more path modification criteria, activating, by the computing system, the one or more vehicle systems to modify the path of the autonomous vehicle, the one or more path modification criteria based in part on the velocity, the trajectory, or the path of the autonomous vehicle, wherein the modifying the path of the autonomous vehicle comprises modifying the one or more destination locations.

2. The computer-implemented method of claim 1, further comprising:
determining, by the computing system, one or more intersection locations for one or more intersections of a road corresponding to the path of the autonomous vehicle; and
determining, by the computing system, at least one of a plurality of turn types associated with a change in the trajectory of the autonomous vehicle within a predetermined distance of a next one of the one or more intersections, wherein the one or more navigational inputs are associated with at least one of the plurality of turn types.

3. The computer-implemented method of claim 2, wherein the plurality of turn types comprises a left turn type associated with the one or more navigational inputs for the autonomous vehicle to turn left at the next one of the intersections, a right turn type associated with the one or more navigational inputs for the autonomous vehicle to turn right at the next one of the intersections, or a U-turn type associated with the one or more navigational inputs for the autonomous vehicle to perform a U-turn after a predetermined period of time elapses.

4. The computer-implemented method of claim 3, wherein the one or more navigational inputs associated with the plurality of turn types are based in part on one or more movements associated with one or more control components of the steering component, the left turn type based in part on a leftward movement of the one or more control components that exceeds a predetermined left turn threshold amount, the right turn type based in part on a rightward movement of the one or more control components that exceeds a predetermined right turn threshold amount, and the U-turn type based in part on a leftward movement or a rightward movement of the one or more control components that exceeds a predetermined U-turn threshold amount.

5. The computer-implemented method of claim 2, further comprising:
determining, by the computing system, an intersection distance from the autonomous vehicle to the next one of the one or more intersections; and
determining, by the computing system, based in part on the velocity of the autonomous vehicle and the intersection distance when one or more intersection criteria are satisfied, wherein the satisfying the one or more path modification criteria is based in part on the intersection distance satisfying the one or more intersection criteria.

6. The computer-implemented method of claim 2, further comprising:
determining, by the computing system, a turn angle based in part on the trajectory of the autonomous vehicle relative to the next one of the one or more intersections; and
determining, by the computing system, when the turn angle and the velocity of the autonomous vehicle satisfy one or more turn angle criteria, wherein the satisfying the one or more path modification criteria is based in part on the turn angle and the velocity satisfying the one or more turn angle criteria.

7. The computer-implemented method of claim 2, further comprising:
determining, by the computing system, based in part on the velocity of the vehicle and the distance to the next one of the one or more intersections, a magnitude of deceleration of the autonomous vehicle that is required for the autonomous vehicle to complete a turn at the next one of the one or more intersections, wherein the satisfying the one or more path modification criteria is based in part on the magnitude of the deceleration of the autonomous vehicle being less than a maximum deceleration threshold.

8. The computer-implemented method of claim 1, further comprising:
determining, by the computing system, one or more locations of one or more objects within a predetermined distance of the autonomous vehicle; and
determining, by the computing system, one or more paths for the autonomous vehicle that traverse the one or more locations of the one or more objects, wherein the satisfying the one or more path modification criteria is based in part on the autonomous vehicle being able to traverse at least one of the one or more paths without intersecting the one or more locations of the one or more objects.

9. The computer-implemented method of claim 1, further comprising:
determining, by the computing system, based in part on traffic regulation data associated with one or more traffic regulations associated with an area within a predetermined distance of the autonomous vehicle, when the modifying the path of the autonomous vehicle can occur without violating the one or more traffic regulations, wherein the satisfying the one or more path modification criteria is based in part on the path of the autonomous vehicle not violating the one or more traffic regulations.

10. The computer-implemented method of claim 1, further comprising:
generating, by the computing system, context data based in part on a time of day, a geographic location, or a passenger identity that is associated with a source of the one or more navigational inputs to the steering component; and
determining, by the computing system, based in part on the context data, when the one or more navigational inputs satisfy one or more navigational criteria, wherein the satisfying the one or more path modification criteria is based in part on the context data satisfying the one or more navigational criteria.

11. The computer-implemented method of claim 1, wherein the steering component comprises a steering wheel, a tiller, a control stick, a tactile control component, an optical control component, a radar control component, a gyroscopic control component, or an auditory control component.

12. One or more tangible, non-transitory computer-readable media storing computer-readable instructions that when executed by one or more processors cause the one or more processors to perform operations, the operations comprising:
determining a velocity, a trajectory, and a path for an autonomous vehicle, wherein the path is based in part on path data comprising a sequence of one or more locations for the autonomous vehicle to traverse, wherein the sequence of one or more locations comprises a current location of the autonomous vehicle and one or more destination locations subsequent to the current location in the sequence;
receiving one or more navigational inputs from a user inside the autonomous vehicle to suggest a modification of the path of the autonomous vehicle via a steering component that is in communication with one or more vehicle systems associated with at least the velocity, the trajectory, or the path of the autonomous vehicle; and
responsive to the one or more navigational inputs satisfying one or more path modification criteria, activating the one or more vehicle systems to modify the path of the autonomous vehicle, the one or more path modification criteria based in part on the velocity, the trajectory, or the path of the autonomous vehicle, wherein the modifying the path of the autonomous vehicle comprises modifying the one or more destination locations.

13. The one or more tangible, non-transitory computer-readable media of claim 12, further comprising:
determining one or more intersection locations for one or more intersections of a road corresponding to the path of the autonomous vehicle; and
determining at least one of a plurality of turn types associated with a change in the trajectory of the autonomous vehicle within a predetermined distance of a next one of the one or more intersections, wherein the one or more navigational inputs are associated with at least one of the plurality of turn types.

14. The one or more tangible, non-transitory computer-readable media of claim 13, further comprising:
determining, based in part on the velocity of the vehicle and the distance to the next one of the one or more intersections, a magnitude of deceleration of the autonomous vehicle that is required for the autonomous vehicle to complete a turn at the next one of the one or more intersections, wherein the satisfying the one or more path modification criteria is based in part on the magnitude of the deceleration of the autonomous vehicle being less than a maximum deceleration threshold.

15. The one or more tangible, non-transitory computer-readable media of claim 12, further comprising:
determining one or more locations of one or more objects within a predetermined distance of the autonomous vehicle; and
determining one or more paths for the autonomous vehicle that traverse the one or more locations of the one or more objects, wherein the satisfying the one or more path modification criteria is based in part on the autonomous vehicle being able to traverse at least one of the one or more paths without intersecting the one or more locations of the one or more objects.

16. A computing system comprising:
one or more processors;
a memory comprising one or more computer-readable media, the memory storing computer-readable instructions that when executed by the one or more processors cause the one or more processors to perform operations comprising:
determining a velocity, a trajectory, and a path for an autonomous vehicle, wherein the path is based in part on path data comprising a sequence of one or more locations for the autonomous vehicle to traverse, wherein the sequence of one or more locations comprises a current location of the autonomous vehicle and one or more destination locations subsequent to the current location in the sequence;
receiving one or more navigational inputs from a user inside the autonomous vehicle to suggest a modification of the path of the autonomous vehicle via a steering component that is in communication with one or more vehicle systems associated with at least the velocity, the trajectory, or the path of the autonomous vehicle; and
responsive to the one or more navigational inputs satisfying one or more path modification criteria, activating the one or more vehicle systems to modify the path of the autonomous vehicle, the one or more path modification criteria based in part on the velocity, the trajectory, or the path of the autonomous vehicle, wherein the modifying the path of the autonomous vehicle comprises modifying the one or more destination locations.

17. The computing system of claim 16, further comprising:
determining one or more intersection locations for one or more intersections of a road corresponding to the path of the autonomous vehicle; and
determining at least one of a plurality of turn types associated with a change in the trajectory of the autonomous vehicle within a predetermined distance of a next one of the one or more intersections, wherein the one or more navigational inputs are associated with at least one of the plurality of turn types.

18. The computing system of claim 17, further comprising:
determining, based in part on the velocity of the vehicle and the distance to the next one of the one or more intersections, a magnitude of deceleration of the autonomous vehicle that is required for the autonomous vehicle to complete a turn at the next one of the one or more intersections, wherein the satisfying the one or more path modification criteria is based in part on the magnitude of the deceleration of the autonomous vehicle being less than a maximum deceleration threshold.

19. The computing system of claim 16, further comprising:
determining one or more locations of one or more objects within a predetermined distance of the autonomous vehicle; and
determining one or more paths for the autonomous vehicle that traverse the one or more locations of the one or more objects, wherein the satisfying the one or more path modification criteria is based in part on the autonomous vehicle being able to traverse at least one of the one or more paths without intersecting the one or more locations of the one or more objects.

20. The computing system of claim 16, wherein the steering component comprises a steering wheel, a tiller, a control stick, a tactile control component, an optical control component, a radar control component, a gyroscopic control component, or an auditory control component.
